(19) United States
(12) Patent Application Publication
(10) Pub. No.: US 2023/0091461 A1
(43) Pub. Date: Mar. 23, 2023

(54) INFORMATION PROCESSING APPARATUS, COMMUNICATION APPARATUS, CONTROL METHOD THEREFOR, AND STORAGE MEDIUM

(71) Applicant: CANON KABUSHIKI KAISHA, Tokyo (JP)

(72) Inventor: Chisei Sumita, Tokyo (JP)

(21) Appl. No.: 17/932,101

(22) Filed: Sep. 14, 2022

(30) Foreign Application Priority Data
Sep. 17, 2021 (JP) 2021-152129

(51) Int. Cl. H04W 76/10; H04W 12/0431

(52) U.S. Cl. CPC H04W 76/10; H04W 12/0431; H04W 84/12

(57) ABSTRACT

A communication apparatus is configured to communicate with an information processing apparatus. The communication apparatus includes a first control unit configured to, based on a start request being received from the information processing apparatus via first communication with the information processing apparatus using a first protocol, perform first control to start a first state capable of performing second communication with the information processing apparatus using a second protocol different from the first protocol.

### BACKGROUND

### Field

Aspects of the present disclosure generally relate to an information processing apparatus, a communication apparatus, a control method therefor, and a storage medium.

### Description of the Related Art

Japanese Patent Application Laid-Open No. 2016-127545 discusses a technique in which an information processing apparatus such as a personal computer (PC) transmits information about an access point to a communication apparatus such as a printer, thus causing the communication apparatus and the access point to connect to each other.

Furthermore, with the popularization of the above-described function of transmitting, to a communication apparatus, connection information for use in connecting to an access point, there has been a demand for improving the convenience of such a function.

### SUMMARY

Various embodiments of the present disclosure increase the convenience of a function for causing a communication apparatus and an access point to connect to each other.

According to one embodiment of the present disclosure, a communication apparatus configured to communicate with an information processing apparatus is provided that includes a first control unit configured to, based on a start request being received from the information processing apparatus via first communication with the information processing apparatus using a first protocol, perform first control to start a first state capable of performing second communication with the information processing apparatus using a second protocol different from the first protocol. The communication apparatus also includes a transmission unit configured to transmit second protocol related information to be used for the second communication with the information processing apparatus using the second protocol, the second protocol related information being transmitted via the first communication with the information processing apparatus using the first protocol. The communication apparatus further includes a communication unit configured to perform the second communication with the information processing apparatus using the second protocol, the second communication being based on the second protocol related information transmitted using the first protocol, and a second control unit configured to, in a case where connection information to be used for the communication apparatus to connect to an access point has been acquired from the information processing apparatus via the second communication, perform second control to establish a connection between the communication apparatus and the access point using the connection information.

Further features of the present disclosure will become apparent from the following description of example embodiments with reference to the attached drawings.

### BRIEF DESCRIPTION OF THE DRAWINGS

FIG. 1 is a diagram illustrating configurations of an information processing apparatus, a communication apparatus, and an access point according to one embodiment.

FIG. 2 is a diagram illustrating an example of a Generic Attribute Profile (GATT) database of the communication apparatus according to one embodiment.

FIGS. 3A and 3B are flowcharts illustrating the flow of processing which the information processing apparatus performs in network setup processing according to one embodiment.

FIG. 4 is a diagram illustrating an example of a screen for QR code® image capturing, which a setting application displays according to one embodiment.

FIG. 5 is a sequence diagram illustrating processing which is performed by the information processing apparatus and the communication apparatus according to one embodiment.

FIG. 6 is a diagram illustrating an example of a Wi-Fi Easy Connect (WEC) start screen according to one embodiment.

FIG. 7 is a sequence diagram illustrating processing which is performed by the information processing apparatus and the communication apparatus according to one embodiment.

FIG. 8 is a flowchart illustrating the flow of processing which the communication apparatus performs in the network setup processing according to one embodiment.

FIG. 9 is a flowchart illustrating the flow of processing which the communication apparatus performs in the network setup processing according to one embodiment.

FIG. 10 is a flowchart illustrating Device Provisioning Protocol (DPP) awaiting mode start processing according to one embodiment.

FIG. 11 is a flowchart illustrating processing for WEC which the communication apparatus performs according to one embodiment.

### DESCRIPTION OF THE EMBODIMENTS

Various example embodiments, features, and aspects of the present disclosure will be described in detail below with reference to the drawings. However, it should be understood that the below description does not limit the scope of the present disclosure to the below described example embodiments, features, and aspects. For example, a configuration obtained by making modifications or improvements as appropriate based on the knowledge of a person of ordinary skill in the art, also falls within the scope of the present disclosure, as long as the configuration does not depart from the spirit of the present disclosure.

Next, an information processing apparatus and a communication apparatus which are included in a communication system according to an example embodiment of the present disclosure are described. While, in the present example embodiment, a smartphone is described as an example of the information processing apparatus, the present example embodiment is not limited to implementations involving smartphones. For example, in other embodiments, various apparatuses, such as a mobile terminal, a personal computer (PC), a tablet terminal, a personal digital assistant (PDA), and a digital camera, can be used as the information processing apparatus. Moreover, while, in the present example embodiment, a printer is described as an example of the communication apparatus, the present example embodiment is not limited to implementations involving printers, and various apparatuses can be applied as the communication apparatus, as long as those are capable of communicating with the information processing apparatus. For example, the applicable printer includes, for example, an inkjet printer, a full-color laser beam printer, and a monochrome printer. Moreover, not only a printer but also a copying machine, a facsimile apparatus, a portable terminal, a smartphone, a notebook PC, a tablet terminal, a PDA, a digital camera, a music playback device, a television set, or a smart speaker can be applied as the communication apparatus. Besides, a multifunction peripheral equipped with a plurality of functions including, for example, a copying function, a facsimile function, and a printing function can also be applied as the communication apparatus.

Moreover, in the present example embodiment, in a case where the information processing apparatus is compatible with a function called Wi-Fi Easy Connect™ (Wi-Fi CERTIFIED Easy Connect®) (WEC), the information processing apparatus is able to execute such a function. WEC is a function which performs network setup of another apparatus with use of Device Provisioning Protocol (DPP) formulated by the Wi-Fi Alliance. Furthermore, network setup of another apparatus is, specifically, processing for causing another apparatus to connect to an access point, which forms a network. In WEC, communications are performed between a device which operates in the role of “configurator” (hereinafter referred to as a “configurator device”) and a device which operates in the role of “enrollee” (hereinafter referred to as an “enrollee device”). The configurator device acquires bootstrapping information from the enrollee device. The bootstrapping information includes, for example, identification information (e.g., media access control (MAC) address) about the enrollee device and public key information which is used to perform secure communications with the enrollee device. In the present example embodiment, the bootstrapping information is described as “WEC-related information”. Furthermore, another pieces of information can also be treated as WEC-related information. Then, the configurator device performs wireless communication with the enrollee device with use of the acquired bootstrapping information. Specifically, for example, the configurator device encrypts a protocol key with use of a public key included in the bootstrapping information, and transmits the encrypted protocol key to the enrollee device. Then, the configurator device encrypts a common key based on the encrypted protocol key, and transmits information encrypted with use of the common key to the enrollee device. Furthermore, information to be transmitted here is, specifically, for example, connection information used for connecting to an access point. Then, the enrollee device establishes a wireless connection with an access point using the connection information received from the configurator device. Furthermore, in the description of network setup processing using WEC in the present example embodiment, an information processing apparatus compatible with WEC is assumed to operate as a configurator device and a communication apparatus compatible with WEC is assumed to operate as an enrollee device.

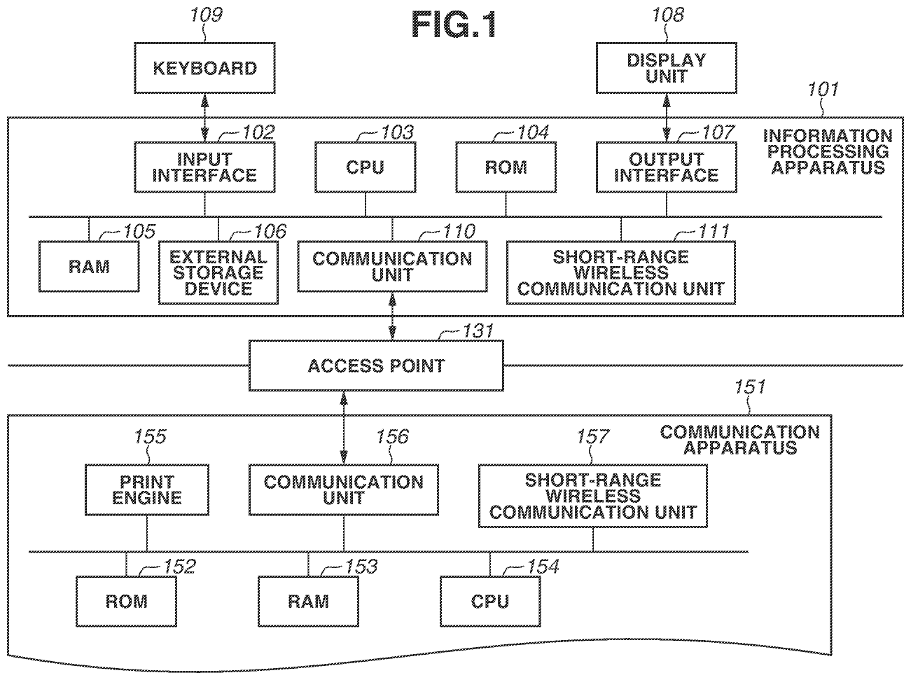

First, configurations of an information processing apparatus in the present example embodiment and a communication apparatus capable of communicating with the information processing apparatus in the present example embodiment are described with reference to the block diagram of FIG. 1. Moreover, while, in the present example embodiment, the following configurations are described as an example, the present example embodiment is directed to functions applicable with respect to an apparatus capable of communicating with the communication apparatus and should not be construed to limit functions thereof to those illustrated in FIG. 1.

An information processing apparatus 101 serves as the information processing apparatus in the present example embodiment. The information processing apparatus 101 includes, for example, an input interface 102, a central processing unit (CPU) 103, a read-only memory (ROM) 104, a random access memory (RAM) 105, an external storage device 106, an output interface 107, a display unit 108, a communication unit 110, and a short-range wireless communication unit 111. For example, the CPU 103, the ROM 104, and the RAM 105 are configured to form a computer of the information processing apparatus 101.

The input interface 102 is an interface for receiving a data input or an operation instruction from the user issued by an operation unit such as a keyboard 109 being operated. Furthermore, the operation unit can be, for example, a physical keyboard or physical buttons, or can be, for example, a software keyboard or software buttons which are displayed on the display unit 108. Thus, the input interface 102 can be configured to receive an input from the user via the display unit 108.

The CPU 103 is a system control unit, and controls the entire information processing apparatus 101.

The ROM 104 stores fixed data such as control programs, data tables, and a built-in operating system (OS) program, which the CPU 103 executes. In the present example embodiment, the control programs stored in the ROM 104 are used to perform software execution control, such as scheduling, task switching, and interrupt processing, under the control of the built-in OS stored in the ROM 104.

The RAM 105 is configured with, for example, a static random access memory (SRAM), which requires a backup power source. Furthermore, the RAM 105 causes data to be retained by a primary battery for data backup (not illustrated) and is, therefore, able to store important data, such as program control variables, without volatilizing such data. Moreover, a memory area for storing, for example, setting information about the information processing apparatus 101 or management data about the information processing apparatus 101 is also provided in the RAM 105. Moreover, the RAM 105 is also used as a main memory and a work memory for the CPU 103.

The external storage device 106 stores, for example, an application program for performing network setup of a communication apparatus 151 (hereinafter referred to as a “setting application”) and a printing information generation program for generating printing information which is interpretable by the communication apparatus 151. The setting application is an application program for performing setting of an access point serving as a connection destination of the communication apparatus 151 with use of, for example, WEC. Furthermore, the setting application can be configured to further include a function other than the network setup function. For example, the setting application can be configured to further include a function for causing the communication apparatus 151 to perform printing, a function for causing an original set on the communication apparatus 151 to be scanned, or a function for checking the state of the communication apparatus 151. For example, the setting application is stored in the external storage device 106 by being installed from an external server by the Internet communication via the communication unit 110. Moreover, the external storage device 106 stores various programs, such as an information transmission and reception control program for performing transmission and reception between the information processing apparatus 101 and the communication apparatus 151, to which the information processing apparatus 101 is connecting via the communication unit 110, and various pieces of information which these programs use.

The output interface 107 is an interface which performs control for the display unit 108 to perform displaying of data and perform notification of the state of the information processing apparatus 101.

The display unit 108 is configured with, for example, a light-emitting diode (LED) or a liquid crystal display (LCD), and performs displaying of data and notification of the state of the information processing apparatus 101.

The communication unit 110 is a configuration which connects to apparatuses, such as the communication apparatus 151 and an access point 131, to perform data communication. For example, the communication unit 110 is able to connect to an access point (not illustrated) included in the communication apparatus 151. By the communication unit 110 and the access point included in the communication apparatus 151 connecting to each other, the information processing apparatus 101 and the communication apparatus 151 become able to communicate with each other. Furthermore, the communication unit 110 can be configured to directly communicate with the communication apparatus 151 via wireless communication, and can be configured to communicate with the communication apparatus 151 via an external device present outside of the information processing apparatus 101 or the communication apparatus 151. Furthermore, the external device includes an external access point (e.g., the access point 131) present outside of the information processing apparatus 101 and the communication apparatus 151 and a device which is other than an access point and is able to relay communication. In the present example embodiment, the wireless communication method which the communication unit 110 uses is assumed to be Wi-Fi® (Wireless Fidelity), which is a communication standard compliant with the IEEE 802.11 series. Then, the above-mentioned WEC is assumed to be executed by the communication unit 110 performing communication. Moreover, examples of the access point 131 include devices such as a wireless local area network (LAN) router. Furthermore, in the present example embodiment, a method in which the information processing apparatus 101 and the communication apparatus 151 directly connect to each other without via an access point is referred to as a “direct connection method”. Moreover, a method in which the information processing apparatus 101 and the communication apparatus 151 connect to each other via an external access point is referred to as an “infrastructure connection method”.

The short-range wireless communication unit 111 is a configuration which wirelessly connects to an apparatus such as the communication apparatus 151 at close range to perform data communication, and performs communication by a communication method different from that of the communication unit 110. The short-range wireless communication unit 111 is able to connect to, for example, a short-range wireless communication unit 157 included in the communication apparatus 151. Examples of the communication method which the short-range wireless communication unit 111 uses include Near Field Communication (NFC), Bluetooth® Classic, Bluetooth® Low Energy (BLE), and Wi-Fi Aware. In the description of the present example embodiment, a wireless communication method which the short-range wireless communication unit 111 uses is assumed to be Bluetooth® Low Energy (BLE). In the present example embodiment, the information processing apparatus 101 operates as a scanner in the BLE standard, and, after connecting to the communication apparatus 151 via the BLE communication, the information processing apparatus 101 operates as a master in the BLE standard.

In the present example embodiment, the information processing apparatus 101 executes WEC by the function of the OS of the information processing apparatus 101 based on an execution instruction for network setup processing issued by the setting application.

The communication apparatus 151 serves as a communication apparatus in the present example embodiment. The communication apparatus 151 includes, for example, a ROM 152, a RAM 153, a CPU 154, a print engine 155, a communication unit 156, and a short-range wireless communication unit 157. For example, the ROM 152, the RAM 153, and the CPU 154 are configured to form a computer of the communication apparatus 151.

The communication unit 156 includes, as an internal access point of the communication apparatus 151, an access point for connecting to an apparatus such as the information processing apparatus 101. Furthermore, the access point is able to connect to the communication unit 110 of the information processing apparatus 101. The communication unit 156 enabling the access point causes the communication apparatus 151 to operate as an access point. Furthermore, the communication unit 156 can wirelessly connect directly to the information processing apparatus 101 or can wirelessly connect to the information processing apparatus 101 via the access point 131. In the present example embodiment, the wireless communication method which the communication unit 156 uses is assumed to be a communication standard compliant with the IEEE 802.11 series. Moreover, in the following description, Wi-Fi® (Wireless Fidelity) is a communication standard compliant with the IEEE 802.11 series. Moreover, if the communication apparatus 151 is compatible with WEC, the above-mentioned WEC is assumed to be executed by the communication unit 156 performing communication. Moreover, the communication unit 156 can include hardware operating as an access point, or can operate as an access point by software for causing the communication unit 156 to operate as an access point.

The communication apparatus 151 in the present example embodiment is able to operate in an infrastructure mode and a peer to peer (P2P) mode, which are modes (states) for performing communication using the communication unit 156.

The infrastructure mode is a form in which the communication apparatus 151 performs communication with another apparatus such as the information processing apparatus 101 via an external device (e.g., the access point 131) forming a network. A connection to an external access point which is established by the communication apparatus 151 operating in the infrastructure mode is referred to as “infrastructure connection”. In the present example embodiment, in the infrastructure connection, the communication apparatus 151 operates as a slave station and the external access point operates as a master station. Furthermore, in the present example embodiment, the master station is a device which determines a communication channel for use in a network to which the master station belongs, and the slave station is a device which does not determine a communication channel for use in a network to which the slave station belongs but uses the communication channel which the master station has determined.

The P2P mode is a form in which the communication apparatus 151 directly communicates with another apparatus such as the information processing apparatus 101 without via an external device forming a network. In the present example embodiment, the P2P mode is assumed to include an access point (AP) mode in which the communication apparatus 151 operates as an access point. Connection information (a service set identifier (SSID) or a password) about an access point which is enabled within the communication apparatus 151 in the AP mode is assumed to be optionally settable by the user. Furthermore, the P2P mode can include, for example, a Wi-Fi Direct (WFD) mode for the communication apparatus 151 to perform communication by Wi-Fi Direct (WFD). Furthermore, which of a plurality of WFD-compatible devices operates as a master station is determined according to, for example, a sequence called “group owner negotiation”. Furthermore, a master station can be determined without the group owner negotiation being performed. An apparatus which is a WFD-compatible device and functions as a master station is particularly referred to as a “group owner”. A direct contact with another apparatus which is established by the communication apparatus 151 operating in the P2P mode is referred to as “direct connection”. In the present example embodiment, in the direct connection, the communication apparatus 151 operates as a master station and another apparatus operates as a slave station.

Moreover, in the present example embodiment, the communication apparatus 151 is able to operate in a network setup mode, which is a mode for performing network setup of the communication apparatus 151, in response to receiving a predetermined operation from the user. The network setup mode is a mode for performing any one of network setup using the BLE communication and network setup using the Wi-Fi communication. When operating in the network setup mode, the communication apparatus 151 uses the communication unit 156 to operate as an access point for setup which is enabled during the process of operating in the network setup mode.

The access point for setup is an access point different from an access point which is enabled during the above-mentioned AP mode. Moreover, the SSID of the access point for setup is assumed to include a predetermined character string which is recognizable by the setting application of the information processing apparatus 101. Moreover, the access point for setup is assumed to be an access point which does not require a password for connection. Moreover, the communication apparatus 151 operating in the network setup mode is assumed to use a predetermined communication protocol (a communication protocol for setup) in performing a communication with the information processing apparatus 101 connecting to the access point for setup. Specifically, the communication protocol for setup is, for example, Simple Network Management Protocol (SNMP). After starting an operation in the network setup mode, the communication apparatus 151 stops an operation in the network setup mode, thus disabling the access point for setup, when a predetermined time has elapsed. This is because, since the access point for setup is an access point which does not require a password as mentioned above, if the access point for setup is enabled for a long time, the possibility of receiving a request for connection from an inappropriate apparatus may increase. Furthermore, the access point for setup can be an access point which requires a password. In that case, a password for use in connection with the access point for setup is assumed to be a fixed (unchangeable by the user) password which the setting application previously recognizes.

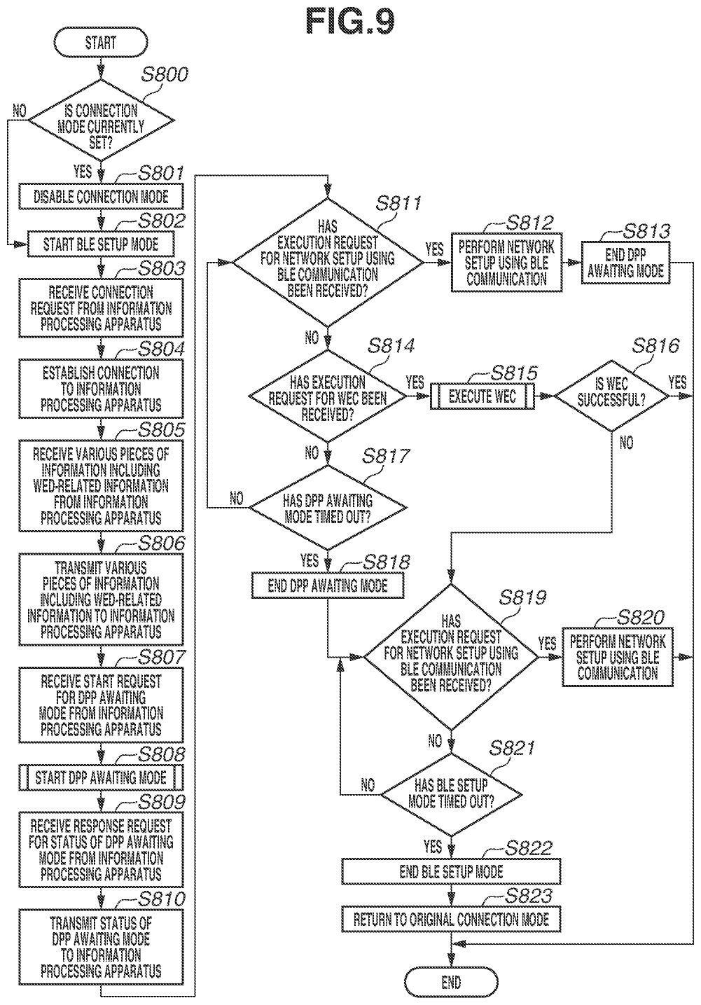

Additionally, in the present example embodiment, the communication apparatus 151 is able to operate in a DPP awaiting mode, which is a mode for performing network setup of the communication apparatus 151 using the DPP. The DPP awaiting mode is described below with reference to FIG. 9.

The short-range wireless communication unit 157 is a configuration which wirelessly connects to an apparatus such as the information processing apparatus 101 at close range, and is able to connect to, for example, the short-range wireless communication unit 111 included in the information processing apparatus 101. Examples of the communication method which the short-range wireless communication unit 157 uses include NFC, Bluetooth® Classic, BLE, and Wi-Fi Aware.

In the present example embodiment, as mentioned above, the communication apparatus 151 is able to operate in a network setup mode, which is a mode for performing network setup of the communication apparatus 151, in response to receiving a predetermined operation from the user. When operating in the network setup mode, the communication apparatus 151 is able to further operate in a BLE setup mode, which is capable of performing setup using the BLE communication and capable of performing the BLE communication. Specifically, when operating in a mode capable of performing the BLE communication, the communication apparatus 151 outputs, as a beacon signal, advertising information for BLE at specific intervals. Furthermore, the communication apparatus 151 does not perform setup using the BLE communication but is able to perform another function using the BLE communication, and the communication apparatus 151 is also able to operate in a non-BLE setup mode, which is capable of performing the BLE communication. When being in the non-BLE setup mode, the communication apparatus 151 transmits advertising information indicating that the communication apparatus 151 is in the non-BLE setup mode, and, when being in the BLE setup mode, the communication apparatus 151 transmits advertising information indicating that the communication apparatus 151 is in the BLE setup mode. With this processing, the communication apparatus 151 transmits advertising information indicating that the communication apparatus 151 is in the BLE setup mode to the information processing apparatus 101. Furthermore, the communication apparatus 151 can be configured to transmit advertising information with the same content when being in the non-BLE setup mode and when being in the BLE setup mode. Then, when receiving a probe request transmitted from the information processing apparatus 101 having received the advertising information with the same content, the communication apparatus 151 can transmit advertising information with a content differing depending on whether the communication apparatus 151 is in the BLE setup mode or the non-BLE setup mode. Thus, in the present example embodiment, the communication apparatus 151 operates as an advertiser in the BLE standard, and, after connecting to the information processing apparatus 101 via the BLE communication, the communication apparatus 151 operates as a slave in the BLE standard. Advertising information for BLE is configured with, for example, Preamble, which is data for clock synchronization between devices which transmit and receive advertising information, Access Address, which is data for frame synchronization related to advertising information, Protocol Data Unit (PDU), which is a real data portion in advertising information, Cyclic Redundancy Check (CRC), which is a data error detection code value for the PDU, and Constant Tone Extension (CTE), which is data for use in causing devices which transmit and receive advertising information to detect mutual directions. Additionally, the PDU is configured with a header and a payload, the header has, stored therein, for example, the type of advertising information and size information about the payload. The payload is configured with device name, connection information, TxPower (signal transmission strength), and identification information. The device name has, stored therein, a user-friendly name of the information processing apparatus 101. The connection information has, stored therein, connection information for connecting to the communication apparatus 151 via the BLE communication. The TxPower has, stored therein, transmission power of advertising information. A terminal side which has received advertising information measures TxPower and a received signal strength indication (RSSI), thus being able to measure a distance from the communication apparatus 151 to the information processing apparatus 101. The identification information has, stored therein, identification (ID) information specific to the communication apparatus 151 and connection compatibility information concerning WEC, thus indicating that the communication apparatus 151 is able to perform setup using WEC.

Furthermore, only in a case where the communication apparatus 151 has been powered on for the first time by the user or in a case where the communication apparatus 151 has entered into a mode capable of performing the BLE communication by the user operation, the communication apparatus 151 outputs advertising information for BLE, thus reducing execution of a setup which the user does not intend to perform. Additionally, the communication apparatus 151 ends the BLE setup mode after the elapse of a specific time, thus reducing execution of a setup which the user does not intend to perform.

Furthermore, in the advertising information for BLE, there are a connectable mode which allows BLE connection and a non-connectable mode which does not allow BLE connection, as described below. Even switching between such modes enables reducing execution of a setup which the user does not intend to perform.

Furthermore, the communication unit 156 and the short-range wireless communication unit 157 can be a single wireless unit which is one communication module using at least one antenna.

The RAM 153 is configured with, for example, an SRAM, which requires a backup power source. Furthermore, the RAM 153 causes data to be retained by a primary battery for data backup (not illustrated) and is, therefore, able to store important data, such as program control variables, without volatilizing such data. Moreover, a memory area for storing, for example, setting information about the communication apparatus 151 or management data about the communication apparatus 151 is also provided in the RAM 153. Moreover, the RAM 153 is also used as a main memory and a work memory for the CPU 154, and serves as a receive buffer for temporarily storing printing information received from, for example, the information processing apparatus 101 and stores various pieces of information.

The ROM 152 stores fixed data such as control programs, data tables, and an OS program, which the CPU 154 executes. In the present example embodiment, the control programs stored in the ROM 152 are used to perform software execution control, such as scheduling, task switching, and interrupt processing, under the control of the built-in OS stored in the ROM 152.

The CPU 154 is a system control unit, and controls the entire communication apparatus 151.

The print engine 155 forms an image on a recording medium such as paper by applying a recording agent such as ink to the recording medium based on information stored in the RAM 153 or a print job received from, for example, the information processing apparatus 101, and thus outputs a print result. Furthermore, since, generally, the amount of data of a print job transmitted from, for example, the information processing apparatus 101 is large, the communication for a print job requires using a communication method capable of performing high-speed communication. Therefore, the communication apparatus 151 receives a print job via the communication unit 156, which is capable of performing higher-speed communication than the short-range wireless communication unit 157.

Furthermore, a memory, such as an external hard disk drive (HDD) or a Secure Digital (SD) card, can be mounted as an optional device on the communication apparatus 151, and information to be stored in the communication apparatus 151 can be stored in such a memory.

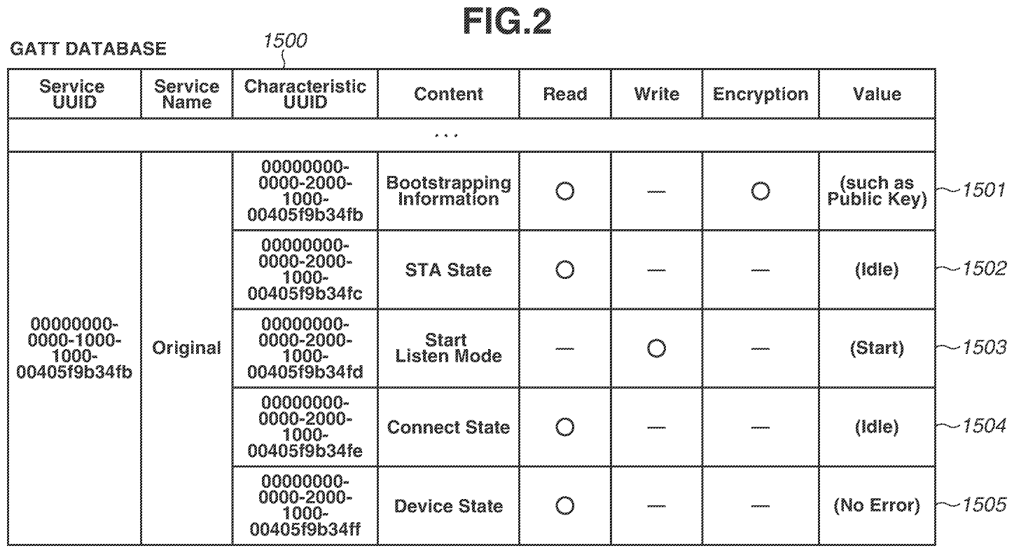

Furthermore, in the present example embodiment, the BLE communication includes a communication using advertising information and a Generic Attribute Profile (GATT) communication. Here, the outline of the GATT communication in the BLE standard is described. Furthermore, the GATT communication is a communication which is implemented by the GATT protocol. Moreover, in the present example embodiment, a communication performed via the BLE connection is assumed to be the GATT communication. In the GATT communication, two roles, i.e., a GATT client and a GATT server, are defined based on a transfer source and a transfer destination of data. The GATT client transmits a write or read request to a GATT database 1500 (FIG. 2) which the GATT server provides, and then receives a response from the GATT server. In the present example embodiment, the communication apparatus 151 is assumed to serve as a GATT server and the information processing apparatus 101 is assumed to serve as a GATT client.

Next, the data format of GATT is described. Data in GATT is configured with three elements called a service, a characteristic, and a descriptor. Furthermore, the descriptor does not need to be included in the data in GATT.

The service, characteristic, and descriptor are able to be identified by a universally unique identifier (UUID) of 32 hexadecimal digits. However, with regard to information defined by the Bluetooth® Special Interest Group (SIG), the UUID is expressed by four hexadecimal digits. Furthermore, the UUID is used as an identifier for uniquely identifying an object on software. The UUID is a numerical value of 128 bits, but, ordinarily, is expressed by a hexadecimal number such as “550e8400-e29b-41d4-a716-446655440000”.

The characteristic has a single value for each characteristic. The descriptor has an attribute value which is used when additional information is required for the characteristic. Each of the service, characteristic, and descriptor is able to be used to set attributes of read and write and an attribute of security with respect to the GATT client.

The GATT client designates the UUID of each of the service, characteristic, and descriptor, thus being able to perform read or write with respect to a value held for each characteristic. However, whether read or write is able to be performed depends on a read attribute or a write attribute which is set for each service or characteristic.

FIG. 2 illustrates a table showing an example of a database configuration which the short-range wireless communication unit 157 of the communication apparatus 151 includes as a GATT server. Five characteristics are provided at a vendor-unique service name Original (Service UUID: 00000000-0000-1000-1000-00405f9b34fb). A read attribute, a write attribute, and an attribute of the presence or absence of encryption on data to be stored are determined with respect to each characteristic.

Bootstrapping information 1501 is a read attribute and is the above-mentioned WEC-related information which is retained in the state of being encrypted. An STA state 1502 is retained as a read attribute indicating whether the communication apparatus 151 is in the state of starting a DPP awaiting mode and enables obtaining information about STA of the communication apparatus 151. A Start Listen Mode 1503 is a database prepared in a write attribute, and, in response to the information processing apparatus 101 writing specific information in the Start Listen Mode 1503, the Start Listen Mode 1503 is able to cause the communication apparatus 151 to start the DPP awaiting mode. A Connect state 1504 is retained as information indicating whether the communication apparatus 151 has succeeded in establishing a connection with an access point by WEC and information indicating whether the communication apparatus 151 has failed in establishing a connection with an access point by WEC. Moreover, the Connect state 1504 is also retained as information concerning a cause of failure. Furthermore, the Connect state 1504 further includes information concerning an idle state before connection, information concerning a DPP connection state in which WEC is being executed by the DPP connection, and information concerning an infrastructure connection-in-progress state indicating an infrastructure connection being in progress.

Moreover, the Connect state 1504 further includes information concerning an error state. The error state includes states in which failures have occurred in the respective phases such as DPP authentication, DPP configuration, and connection and authentication with a connection destination access point. A Device state 1505 is retained as a read attribute indicating, for example, an operating state, communication condition, and error state in the communication apparatus 151.

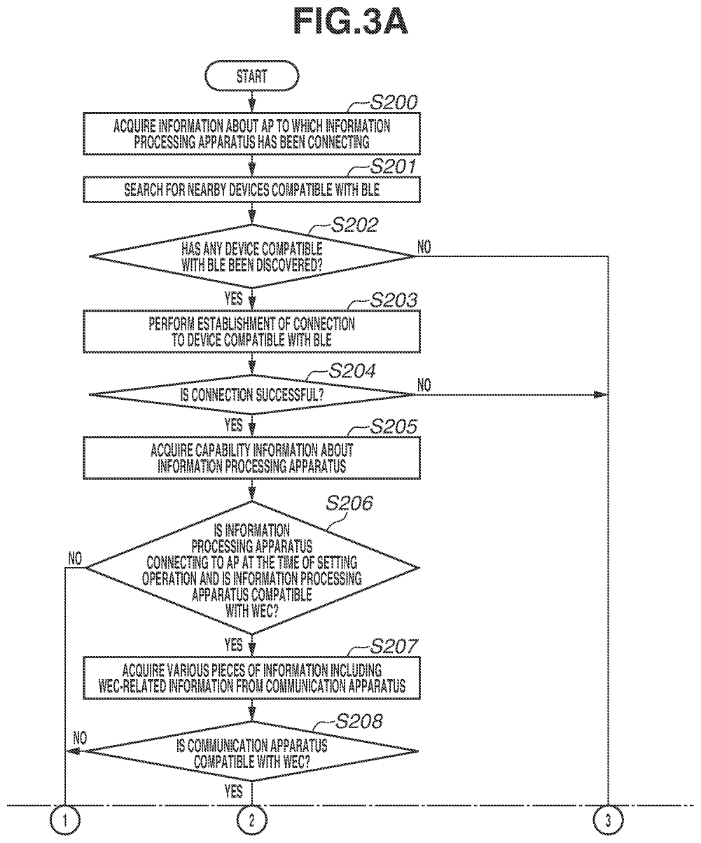

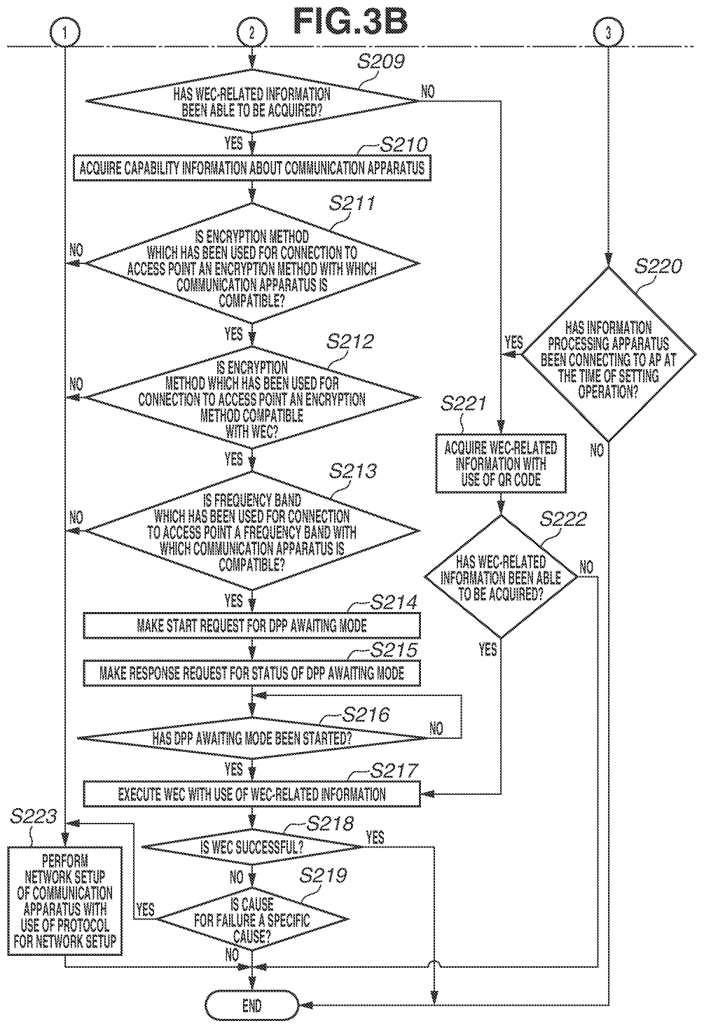

FIGS. 3A and 3B are flowcharts illustrating the flow of processing which the information processing apparatus 101 performs in the network setup processing in the present example embodiment. The flowcharts of FIGS. 3A and 3B are implemented by the CPU 103 reading out a setting application stored in, for example, the ROM 104 or the external storage device 106 onto the RAM 105 and executing the setting application. Moreover, the flowcharts of FIGS. 3A and 3B are started in response to a predetermined operation for network setup (hereinafter referred to as a “setting operation”) being performed in a screen which the setting application displays.

First, in step S200, the CPU 103 acquires information about an access point to which the information processing apparatus 101 has been connecting by Wi-Fi at least when the setting operation has been performed (hereinafter referred to as a “connected AP”). Furthermore, in the present example embodiment, since, after the setting operation has been performed, the information processing apparatus 101 is not performing switching of an access point serving as a connection destination, the access point is also an access point to which the information processing apparatus 101 is currently connecting in step S200. The information to be acquired includes information for connecting to an access point to which the information processing apparatus 101 is wirelessly connecting by Wi-Fi (e.g., an SSID or information indicating an encryption method). Furthermore, the acquired information is stored in a predetermined storage region of a memory included in the information processing apparatus 101. Furthermore, in a case where, when the setting operation has been performed, the information processing apparatus 101 is not connecting to any access point by Wi-Fi, the present processing is omitted.

Next, in step S201, the CPU 103 instructs the OS of the information processing apparatus 101 to search for devices compatible with BLE near the information processing apparatus 101, and acquires a result of the search from the setting application.

Next, in step S202, the CPU 103 determines whether the communication apparatus 151 compatible with BLE is present in the search result acquired in step S201. As mentioned above, in the present example embodiment, the communication apparatus 151, which operates in a mode capable of performing the BLE communication, outputs advertising information. The CPU 103 reads out, for example, the above-mentioned device name, connection information, and identification information included in the advertising information and thus determines whether the communication apparatus 151 is compatible with BLE. If the result of determination in step S202 is yes (YES in step S202), the CPU 103 advances the processing to step S203, and, if the result of determination in step S202 is no (NO in step S202), the CPU 103 advances the processing to step S220. Furthermore, the CPU 103 can be configured to cause the display unit 108 to display communication apparatuses 151 compatible with BLE and prompt the user to select a communication apparatus 151 network setup of which to perform. Then, in step S203, the CPU 103 can be configured to try to establish a BLE connection between the selected communication apparatus 151 compatible with BLE and the information processing apparatus 101.

In step S203, the CPU 103 tries to establish a BLE connection between the communication apparatus 151 compatible with BLE, included in the search result, and the information processing apparatus 101.

Next, in step S204, the CPU 103 determines whether the establishment of the BLE connection in step S203 is successful. If the result of determination in step S204 is yes (YES in step S204), the CPU 103 advances the processing to step S205, and, if the result of determination in step S204 is no (NO in step S204), the CPU 103 advances the processing to step S220.

In step S205, the CPU 103 acquires capability information about the information processing apparatus 101 from the OS. In the present example embodiment, the capability information includes information indicating whether the information processing apparatus 101 is compatible with WEC. Furthermore, the content of capability information differs depending on, for example, the model or model number of the information processing apparatus 101.

Next, in step S206, the CPU 103 determines whether the information processing apparatus 101 is connecting to an access point by Wi-Fi when the setting operation has been performed and the information processing apparatus 101 is compatible with WEC. Furthermore, in the present example embodiment, the communication apparatus 151 is able to maintain the BLE connection and the Wi-Fi connection in parallel with each other. Thus, in a case where the information processing apparatus 101 is connecting to an access point by Wi-Fi when the setting operation has been performed, the information processing apparatus 101 is connecting to the access point even at the time of determination in step S206. Therefore, in the present example embodiment, the access point to which the information processing apparatus 101 is connecting by Wi-Fi when the setting operation has been performed is also an access point to which the information processing apparatus 101 is currently connecting by Wi-Fi. Here, for example, in a case where the information processing apparatus 101 is not connecting to an access point by Wi-Fi when the setting operation has been performed, the result of determination becomes no. Moreover, for example, in a case where, while the information processing apparatus 101 is connecting to an access point by Wi-Fi when the setting operation has been performed, the information processing apparatus 101 is not compatible with WEC, the result of determination becomes no. Furthermore, whether the information processing apparatus 101 is connecting to an access point by Wi-Fi when the setting operation has been performed is determined based on whether information about the connected AP is currently stored in the above-mentioned predetermined storage region. Moreover, whether the information processing apparatus 101 is compatible with WEC is determined based on the content of capability information acquired in step S205. If the result of determination in step S206 is yes (YES in step S206), the CPU 103 advances the processing to step S207, and, if the result of determination in step S206 is no (NO in step S206), the CPU 103 advances the processing to step S223.

In step S207, the CPU 103 tries to acquire various pieces of information from the communication apparatus 151 via a BLE connection between the communication apparatus 151 operating in the BLE setup mode and the information processing apparatus 101. Specifically, the CPU 103 reads out various pieces of information from the above-mentioned GATT database 1500 of the communication apparatus 151. Moreover, the various pieces of information to be acquired by this include, for example, the above-mentioned WEC-related information and information indicating whether the communication apparatus 151 is compatible with WEC. Furthermore, in a case where the communication apparatus 151 is not compatible with WEC, information indicating that the communication apparatus 151 is not compatible with WEC is acquired and the WEC-related information is not acquired. Moreover, in a case where the communication apparatus 151 is not compatible with WEC, neither the WEC-related information nor the information indicating whether the communication apparatus 151 is compatible with WEC may be acquired. Usually, the WEC-related information is also able to be acquired by the communication apparatus 151 displaying a QR code corresponding to the WEC-related information on a display unit and the information processing apparatus 101 reading the displayed QR code with, for example, a camera unit. However, in the present example embodiment, the WEC-related information is acquired via a BLE connection between the communication apparatus 151 operating in the BLE setup mode and the information processing apparatus 101. With this configuration, even if the communication apparatus 151 does not include a display unit for displaying a QR code or even if the information processing apparatus 101 does not include a camera unit for reading a QR code, the information processing apparatus 101 is enabled to acquire WEC-related information.

Next, in step S208, the CPU 103 determines whether the communication apparatus 151 is compatible with WEC, based on the information acquired in step S207. In a case where information indicating that the communication apparatus 151 is compatible with WEC has been acquired, the result of determination in step S208 becomes yes, and, in a case where information indicating that the communication apparatus 151 is compatible with WEC has not been acquired, the result of determination in step S208 becomes no. If the result of determination in step S208 is yes (YES in step S208), the CPU 103 advances the processing to step S209, and, if the result of determination in step S208 is no (NO in step S208), the CPU 103 advances the processing to step S223. Furthermore, in a case where information has not been acquired in step S207, the result of determination in step S208 becomes no.

Next, in step S209, the CPU 103 determines whether WEC-related information has been able to be acquired from the communication apparatus 151 in step S207. If the result of determination in step S209 is yes (YES in step S209), the CPU 103 advances the processing to step S210, and, if the result of determination in step S209 is no (NO in step S209), the CPU 103 advances the processing to step S221. Furthermore, the case where the result of determination in step S209 becomes no is, for example, a case where, while information indicating that the communication apparatus 151 is compatible with WEC has been acquired, WEC-related information has not been acquired due to, for example, a communication error.

In step S210, the CPU 103 acquires capability information about the communication apparatus 151 by the GATT communication via a BLE connection between the communication apparatus 151 operating in the BLE setup mode and the information processing apparatus 101. In the present example embodiment, the capability information about the communication apparatus 151 is assumed to include information indicating an encryption method with which the communication apparatus 151 is compatible and information indicating a frequency band with which the communication apparatus 151 is compatible. The encryption method with which the communication apparatus 151 is compatible is, for example, Wi-Fi Protected Access (WPA), Wi-Fi Protected Access II (WPA2), or Wi-Fi Protected Access 3 (WPA3). Moreover, the information indicating a frequency band with which the communication apparatus 151 is compatible can be information indicating a frequency channel corresponding to a frequency band with which the communication apparatus 151 is compatible. Furthermore, in a configuration in which, as described below, a determination concerning an encryption method with which the communication apparatus 151 is compatible or a determination concerning a frequency band with which the communication apparatus 151 is compatible is not performed, the present processing can be omitted. Furthermore, the capability information can be previously included in the setting application. Thus, the CPU 103 can specify capability information corresponding to the communication apparatus 151 from among a plurality of pieces of capability information prepared for each type or model number of each communication apparatus previously included in the setting application and acquire the specified capability information from the setting application.

Next, in step S211, the CPU 103 determines whether the encryption method which has been used for connection to the connected AP is an encryption method with which the communication apparatus 151 is compatible, based on the capability information acquired in step S210. Furthermore, in the present example embodiment, the encryption method with which the communication apparatus 151 is compatible is WPA, WPA2, or WPA3, and the encryption method with which the communication apparatus 151 is not compatible is Wired Equivalent Privacy (WEP). If the result of determination in step S211 is yes (YES in step S211), the CPU 103 advances the processing to step S212, and, if the result of determination in step S211 is no (NO in step S211), the CPU 103 advances the processing to step S223. Furthermore, the present determination can be performed at different timing. Specifically, for example, the present determination can be performed after the result of determination in step S204 is yes, and, if the result of determination is yes, the CPU 103 can advance the processing to step S205 and, if the result of determination is no, the CPU 103 can advance the processing to step S223.

Next, in step S212, the CPU 103 determines whether the encryption method which has been used for connection to the connected AP is an encryption method compatible with WEC (compatible with the DPP). Furthermore, the encryption method compatible with WEC is, for example, WPA2 or WPA3, and the encryption method incompatible with WEC is, for example, WPA or WEP. Furthermore, the CPU 103 can recognize which is the encryption method compatible with WEC, based on information which the setting application previously retains or based on information which is acquired from the communication apparatus 151. If the result of determination in step S212 is yes (YES in step S212), the CPU 103 advances the processing to step S213, and, if the result of determination in step S212 is no (NO in step S212), the CPU 103 advances the processing to step S223.

Next, in step S213, the CPU 103 determines whether the frequency band which has been used for connection to the connected AP is a frequency band with which the communication apparatus 151 is compatible, based on the capability information acquired in step S210. Furthermore, in the present example embodiment, the communication apparatus 151 is assumed to include a type which is compatible with both a frequency band of 2.4 gigahertz (GHz) and a frequency band of 5 GHz and a type which is compatible with a frequency band of 2.4 GHz but is not compatible with a frequency band of 5 GHz.

Then, the communication apparatus 151 is not able to connect to an access point depending on a frequency band with which the communication apparatus 151 is not compatible. Therefore, for example, in a case where the frequency band which has been used for connection to the connected AP is a frequency band of 5 GHz and the communication apparatus 151 is not compatible with a frequency band of 5 GHz, the result of determination in step S213 becomes no. If the result of determination in step S213 is yes (YES in step S213), the CPU 103 advances the processing to step S214, and, if the result of determination in step S213 is no (NO in step S213), the CPU 103 advances the processing to step S223.

In step S214, the CPU 103 makes a start request for the DPP awaiting mode to the communication apparatus 151 via a BLE connection between the communication apparatus 151 operating in the BLE setup mode and the information processing apparatus 101. Specifically, the CPU 103 writes a specific value to the Start Listen Mode 1503 of the GATT database 1500, thus making a start request for the DPP awaiting mode to the communication apparatus 151.

In step S215, the CPU 103 makes, to the communication apparatus 151, a response information request for information indicating whether the DPP awaiting mode has been executed, via a BLE connection between the communication apparatus 151 operating in the BLE setup mode and the information processing apparatus 101.

In step S216, the CPU 103 determines whether the communication apparatus 151 has started the DPP awaiting mode. Specifically, the CPU 103 reads the STA state 1502 of the communication apparatus 151 and determines whether the value of the STA state 1502 has changed to a value indicating the DPP awaiting mode. If the result of determination in step S216 is yes (YES in step S216), the CPU 103 advances the processing to step S217, and, if the result of determination in step S216 is no (NO in step S216), the CPU 103 repeats the present determination. Thus, if the result of determination in step S216 is no, the CPU 103 repeatedly continues reading the STA state 1502 until the value of the read STA state 1502 changes to a value indicating the DPP awaiting mode.

In step S217, the CPU 103 executes WEC with use of the acquired WEC-related information. Furthermore, the present processing is implemented by the CPU 103 causing the setting application to request the OS to execute WEC. Thus, the setting application does not directly execute WEC but requests the OS to execute WEC as a control operation for executing WEC. The details of the present processing are described below.

In step S218, the CPU 103 determines whether the establishment of a connection between the access point and the communication apparatus 151 is successful, by the executed WEC. The present determination is performed based on whether execution of WEC has been cancelled or based on information indicating the success or failure of a connection with the access point, acquired from the communication apparatus 151. Specifically, the present determination is performed based on information about the Connect state 1504 of the communication apparatus 151. The CPU 103 repeatedly reads information about the Connect state 1504 of the communication apparatus 151, which is acquired with the GATT communication, at a predetermined interval, and thus determines whether the establishment of a connection between the communication apparatus 151 and the access point is successful (not illustrated). If the result of determination in step S218 is yes (YES in step S218), the CPU 103 ends the processing, and, if the result of determination in step S218 is no (NO in step S218), the CPU 103 advances the processing to step S219. Moreover, the setting application can communicate (display) the state of the communication apparatus 151 to the user.

In step S219, the CPU 103 determines whether a cause for the establishment of a connection between the access point and the communication apparatus 151 having been unsuccessful is a specific cause, by the executed WEC. Furthermore, in the present example embodiment, information about a cause for the establishment of a connection between the access point and the communication apparatus 151 having been unsuccessful is assumed to be acquired from the communication apparatus 151 by the executed WEC, and the present determination is assumed to be performed based on the acquired information. Moreover, in the present example embodiment, the specific cause is, for example, an error having occurred in a communication in WEC (cause 1) and an encryption method used for connection between the information processing apparatus 101 and the access point being an encryption method with which the communication apparatus 151 is not compatible (cause 2). Moreover, for example, the specific cause is an encryption method used for connection between the information processing apparatus 101 and the access point being an encryption method with which WEC is not compatible (cause 3). Furthermore, a failure resulting from the cause 2 or cause 3 may occur in a case where WEC has been executed after the result of determination in step S222 is yes. This is because, in a case where WEC is executed after the result of determination in step S222 is yes, unlike a case where WEC is executed after step S215, capability information about the communication apparatus 151 has not yet been acquired and the determination such as that in step S211 or step S212 has not been performed. If the result of determination in step S219 is yes (YES in step S219), the CPU 103 advances the processing to step S223, and, if the result of determination in step S219 is no (NO in step S219), the CPU 103 ends the processing.

Furthermore, processing in step S218 or step S219 can be omitted. Specifically, for example, after step S217, processing can be ended without step S218 or step S219 being performed. Moreover, in a case where the result of determination in step S218 is no, processing can be ended without step S219 being performed.

Next, step S220, which is performed if the result of determination in step S202 is no or if the result of determination in step S204 is no, is described. In step S220, the CPU 103 determines whether the information processing apparatus 101 has been connecting to an access point by Wi-Fi when the setting operation has been performed. The present determination is performed based on whether information about an access point is currently stored in the above-mentioned predetermined storage region. If the result of determination in step S220 is yes (YES in step S220), the CPU 103 advances the processing to step S221, and, if the result of determination in step S220 is no (NO in step S220), the CPU 103 ends the processing.

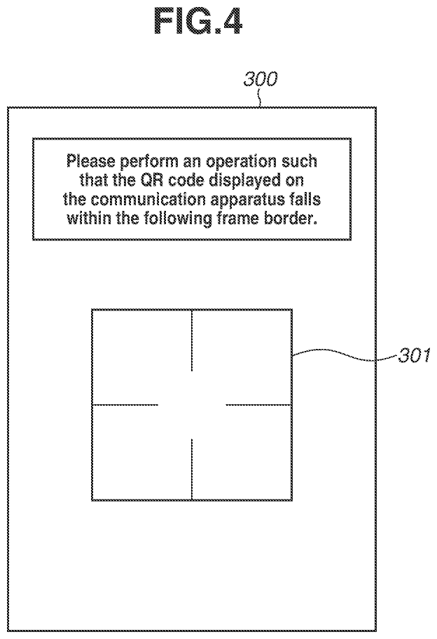

In step S221, the CPU 103 tries to acquire WEC-related information by a method different from the acquisition method for WEC-related information used in step S207. Specifically, for example, the CPU 103 tries to acquire WEC-related information by reading of a QR code as mentioned above. FIG. 4 illustrates an example of a screen for QR code image capturing which the setting application displays. In the screen 300 for QR code image capturing, a frame 301 is displayed and, additionally, in the screen 300, an image which is being captured by a camera unit included in the information processing apparatus 101 is displayed. The user operates the information processing apparatus 101 in such a manner that a QR code which is being captured by the camera unit and which the communication apparatus 151 displays falls within the frame 301. In a case where it is detected that the QR code has fallen within the frame 301, the CPU 103 analyzes the QR code and thus acquires WEC-related information. Furthermore, the acquisition of WEC-related information is not limited to this configuration, and, for example, the CPU 103 can acquire WEC-related information from the communication apparatus 151 by Near-field communication (NFC). Additionally, the CPU 103 can be configured to acquire WEC-related information from the communication apparatus 151 via a Wi-Fi connection between an access point which is enabled by the communication apparatus 151 operating in the network setup mode and the information processing apparatus 101. Furthermore, in a case where the communication apparatus 151 is not compatible with WEC, the communication apparatus 151 is not able to perform displaying of a QR code or transmission of WEC-related information by NFC. In that case, the CPU 103 ends the processing in response to receiving a cancel operation on the setting application from the user.

Next, in step S222, the CPU 103 determines whether WEC-related information has been able to be acquired in step S221.

If the result of determination in step S222 is yes (YES in step S222), the CPU 103 advances the processing to step S217, and, if the result of determination in step S222 is no (NO in step S222), the CPU 103 ends the processing. Furthermore, for example, in a case where the QR code read in step S221 is not a QR code for causing WEC-related information to be acquired or in a case where reading of the QR code is failed, the result of determination in step S222 becomes no. Moreover, in a case where the result of determination in step S222 is no, the CPU 103 can be configured not to end the processing but to advance the processing to step S223. Moreover, in a case where the result of determination in step S222 is yes, the CPU 103 can determine whether the encryption method which has been used for connection to the connected AP is an encryption method compatible with WEC (compatible with the DPP). Then, if the result of determination in step S222 is yes, the CPU 103 can advance the processing to step S217, and, if the result of determination in step S222 is no, the CPU 103 can end the processing or can advance the processing to step S223. Furthermore, in this case, it is assumed that the CPU 103 is aware of which is an encryption method compatible with WEC, based on information previously retained by the setting application.

In this way, in the present example embodiment, in a case where WEC-related information is not able to be acquired by a BLE connection between the communication apparatus 151 operating in a mode capable of performing BLE and the information processing apparatus 101, the CPU 103 tries to acquire WEC-related information by another method. Specifically, for example, the CPU 103 tries to acquire WEC-related information by reading of a QR code. With this processing, even in a case where WEC-related information is not able to be acquired by a BLE connection between the communication apparatus 151 operating in the BLE setup mode and the information processing apparatus 101, the CPU 103 is able to execute WEC.

Next, step S223, which is performed in a case where the result of determination in step S206 is no, in a case where the result of determination in step S208 is no, in a case where the result of determination in any one of step S211 to step S213 is no, or in a case where the result of determination in step S219 is yes, is described. In step S223, the CPU 103 performs network setup of the communication apparatus 151 by a method different from WEC. In the present example embodiment, the method different from WEC is a method of performing network setup of the communication apparatus 151 with use of a communication protocol for setup, which is a protocol different from the protocol for WEC (the DPP). The details of the present processing are described below. After that, the CPU 103 ends the processing.

Furthermore, the content of processing in the above-described flowchart is not limited to the above-described content. For example, in a case where WEC-related information is not able to be acquired by a BLE connection between the communication apparatus 151 operating in the BLE setup mode and the information processing apparatus 101, the CPU 103 can end the processing without trying to acquire WEC-related information by another method. The case where WEC-related information is not able to be acquired by a BLE connection between the communication apparatus 151 operating in the BLE setup mode and the information processing apparatus 101 is, specifically, for example, a case where the result of determination in step S202 is no, a case where the result of determination in step S204 is no, or a case where the result of determination in step S209 is no. Thus, in a case where the result of determination in step S202 is no, in a case where the result of determination in step S204 is no, or in a case where the result of determination in step S209 is no, the CPU 103 can end the processing without performing subsequent processing (step S220 to step S222).

Moreover, for example, while, in the above description, two determinations in step S208 and step S209 are performed after step S207, the present example embodiment is not limited to this configuration. For example, after step S207, instead of two determinations in step S208 and step S209, a determination as to whether WEC-related information has been acquired can be performed. Then, if the result of determination is yes, the CPU 103 can advance the processing to step S210, and, if the result of determination is no, the CPU 103 can advance the processing to step S223, so that a configuration in which processing in step S221 to step S222 is not performed can be employed.

Furthermore, in the present example embodiment, an encryption method compatible with WEC is included in encryption methods with which the communication apparatus 151 is compatible. Therefore, a configuration in which the determination in step S211 is not performed can be employed. Specifically, for example, after step S210, without the determination in step S211 being performed, the determination in step S212 can be performed.

Moreover, for example, a configuration in which an encryption method with which the communication apparatus 151 is compatible is included in encryption methods compatible with WEC, such as a configuration in which the encryption method with which the communication apparatus 151 is compatible is only WPA3 and the encryption methods compatible with WEC are WPA2 and WPA3, can be employed. In that case, a configuration in which the determination in step S212 is not performed can be employed. Specifically, for example, after the result of determination in step S211 is yes, without the determination in step S212 being performed, the determination in step S213 can be performed.

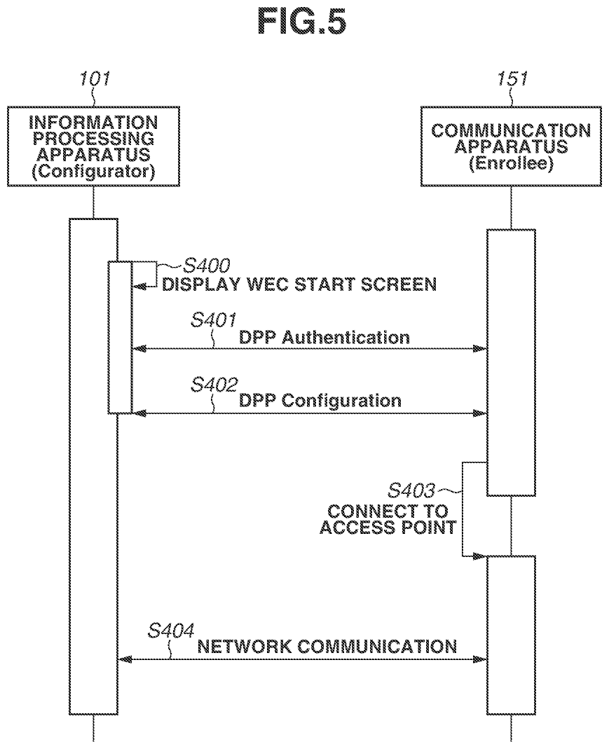

Next, processing which is performed by the information processing apparatus 101 and the communication apparatus 151 in step S216 is described with reference to FIG. 5. The sequence illustrated in FIG. 5 is implemented by, for example, a CPU of each apparatus reading out a program stored in, for example, a ROM of each apparatus or an external storage device onto a RAM of each apparatus and executing the program.

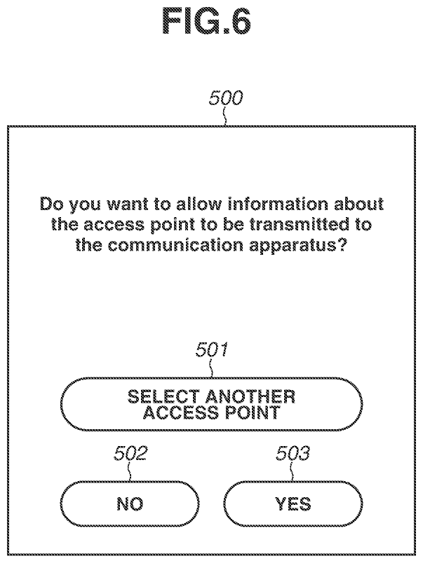

First, in step S400, the information processing apparatus 101 starts WEC using the DPP by the function of an OS. Specifically, first, the information processing apparatus 101 issues a displaying instruction for a WEC start screen from the setting application to the OS, thus displaying the WEC start screen. FIG. 6 illustrates an example of the WEC start screen. The WEC start screen 500 has areas 501, 502, and 503 displayed therein. The area 501 is an area for changing an access point which is set as a setting target using WEC. Furthermore, before the area 501 is operated, the access point which is set as a setting target using WEC is an access point to which the information processing apparatus 101 is currently connecting. In a case where the area 501 has been selected, the information processing apparatus 101 displays a list of access points and sets a new access point selected from the list by the user as a setting target using WEC. Furthermore, the list of access points is assumed to include, for example, an access point discovered by an AP search performed by the information processing apparatus 101 and an access point to which the information processing apparatus 101 has been connected at some point. The area 502 is an area for cancelling execution of WEC, and the area 503 is an area for issuing an instruction for execution of WEC. If the area 502 has been operated, the information processing apparatus 101 ends processing in the present sequence diagram, and then advances the processing to step S217. Furthermore, in this case, WEC is deemed to be failed. Moreover, if the area 503 has been pressed, the information processing apparatus 101 advances the processing to step S401.

In step S401, the WEC application executes an application programming interface (API) for WEC with use of WEC-related information or information about an access point set as a target for setting by WEC, so that an instruction for execution of WEC is issued to the OS. Then, processing called DPP authentication is performed between the information processing apparatus 101 and the communication apparatus 151 by the function of the OS. In the DPP authentication, for example, authentication information and information for use in encrypting information are communicated between the information processing apparatus 101 and the communication apparatus 151, so that authentication of communication between the information processing apparatus 101 and the communication apparatus 151 is performed. Furthermore, various pieces of information which are transmitted from the information processing apparatus 101 in a communication performed in the DPP authentication are encrypted based on WEC-related information previously acquired by the information processing apparatus 101 with processing described below. In the DPP authentication, specifically, first, the information processing apparatus 101 transmits an authentication request as a network setup request using the DPP. Next, the communication apparatus 151, which operates in the DPP mode, is operating in the DPP awaiting mode, which is a mode for awaiting an authentication request, and, therefore, receives the authentication request transmitted from the information processing apparatus 101. The communication apparatus 151, having received the authentication request, tries to decode the received authentication request with a decryption key which the communication apparatus 151 itself retains. Then, when succeeding in the decryption, the communication apparatus 151 transmits an authentication response to the information processing apparatus 101, thus authenticating a communication with the information processing apparatus 101. Furthermore, in a case where the information processing apparatus 101 has not been able to acquire accurate WEC-related information and, thus, have not been able to accurately encrypt information, decryption in the communication apparatus 151 is failed, and, therefore, authentication is failed and the authentication response is not transmitted. In response to the authentication response being received by the information processing apparatus 101, the DPP authentication is completed. Moreover, in the DPP authentication, the DPP is used to perform communications.

Next, in step S402, processing called DPP configuration is performed between the information processing apparatus 101 and the communication apparatus 151 by the function of the OS. In the DPP configuration, the information processing apparatus 101 transmits, to the communication apparatus 151 by WEC, connection information for connecting to an access point set as a setting target by WEC. Furthermore, the connection information includes, for example, information indicating the SSID and password of an access point set as a setting target by WEC and an encryption method. The password to be transmitted at this time is information input by the user on a screen which an application compatible with the OS displays when a connection between the information processing apparatus 101 and the access point is established.

Then, the password is information retained by the OS when a connection between the information processing apparatus 101 and the access point has been established. Moreover, the password is information which the setting application is not retaining.

Moreover, since the password to be transmitted at this time is information which the OS is already retaining and the DPP configuration is processing which is performed by the OS, the password does not need to be newly input by the user on a screen which the setting application displays. Transmitting connection information by WEC as in the present example embodiment enables transmitting a password to the communication apparatus 151 without newly receiving inputting of a password from the user on a screen which the setting application displays and with use of a secure communication. Furthermore, even in the DPP configuration, a communication is performed with use of the DPP.

In step S403, the communication apparatus 151 ends the BLE setup mode and transitions to the infrastructure mode. Moreover, the communication apparatus 151 changes the Connect state 1504 of the GATT database to the DPP connection state, thus indicating a state in which the communication apparatus 151 is connecting to the designated access point by the DPP configuration. Furthermore, the BLE setup mode or the BLE connection can be configured not to be ended but to be maintained. Then, the communication apparatus 151 uses connection information acquired by WEC to try to connect to an access point corresponding to the connection information. In a case where the connection is successful, since then, the communication apparatus 151 becomes able to perform communication via a network which the connected access point forms. When succeeding in connecting to the access point, the communication apparatus 151 changes information about the Connect state 1504 to information indicating that the connection is successful. Moreover, when failing in connecting to the access point, the communication apparatus 151 changes information about the Connect state 1504 to information indicating that the connection is failed. Moreover, the communication apparatus 151 stores the cause of failure in the Connect state 1504. Then, the communication apparatus 151 transmits information indicating whether the connection to the access point has been established to the information processing apparatus 101. Furthermore, specifically, for example, the information processing apparatus 101 reads the Connect state 1504 via the BLE communication, thus being able to check the state of the communication apparatus 151. Furthermore, the communication which is performed via a network which the connected access point forms is performed according to a protocol different from the DPP (specifically, for example, Port9100, Simple Network Management Protocol (SNMP), or a vendor-specific protocol of the communication apparatus 151). Furthermore, the communication apparatus 151 can transmit, to the information processing apparatus 101, information indicating the success or failure of a connection to an access point corresponding to connection information acquired by WEC. Moreover, in a case where the connection to an access point corresponding to connection information acquired by WEC is failed, the communication apparatus 151 can further transmit, to the information processing apparatus 101, information indicating the cause of such a failure. Moreover, these information transmissions can be performed with use of the DPP or can be performed via the maintained BLE connection. Furthermore, examples of the cause of a failure in connection to an access point corresponding to connection information acquired by WEC include an error in communication in WEC, the corresponding access point being undiscoverable, and WEC-related information acquired from the communication apparatus 151 being inappropriate information. Moreover, examples of such a cause include an encryption method for use in connecting to an access point set as a setting target by WEC being an encryption method with which the communication apparatus 151 is not compatible. Moreover, examples of such a cause include an encryption method for use in connecting to an access point set as setting target by WEC being an encryption method with which WEC is not compatible. Furthermore, the information processing apparatus 101 can display, on the display unit 108, information indicating the success or failure of a connection to an access point corresponding to connection information acquired by WEC. Additionally, in a case where the connection to an access point corresponding to connection information acquired by WEC has been failed, the information processing apparatus 101 can display, on the display unit 108, information indicating the cause of such a failure.

In step S404, the information processing apparatus 101 searches for the communication apparatus 151 on a network to which the information processing apparatus 101 itself belongs. The present processing is implemented by the setting application having received, from the OS, a notification indicating that execution of WEC has been ended. Furthermore, the state in which execution of WEC has been ended is a state in which the DPP configuration is successful. Then, in a case where the communication apparatus 151 has been discovered, the information processing apparatus 101 requests capability information from the communication apparatus 151, and the communication apparatus 151 transmits capability information to the information processing apparatus 101. With this processing, the information processing apparatus 101 registers information about the communication apparatus 151 on the setting application, and, since then, becomes able to perform a communication with the communication apparatus 151 by the setting application. Specifically, for example, the information processing apparatus 101 becomes able to transmit a print job to the communication apparatus 151 by the setting application. Furthermore, at this time, in a case where the information processing apparatus 101 belongs to a network formed by an access point to which the communication apparatus 151 has connected by WEC, the information processing apparatus 101 becomes able to perform a communication with the communication apparatus 151 via the access point. Moreover, in a case where a communication between the information processing apparatus 101 and the communication apparatus 151 is not able to be performed, such as a case where an access point to which the communication apparatus 151 has connected is not an access point to which the information processing apparatus 101 is connecting, a request or acquisition of capability information is omitted. Furthermore, a communication in step S404 is performed with use of, for example, a communication protocol different from both the DPP and a communication protocol for setup (specifically, for example, Canon HTTP Management Protocol (CHMP)). After that, the information processing apparatus 101 ends the processing in the present sequence diagram, and then advances the processing to step S218.

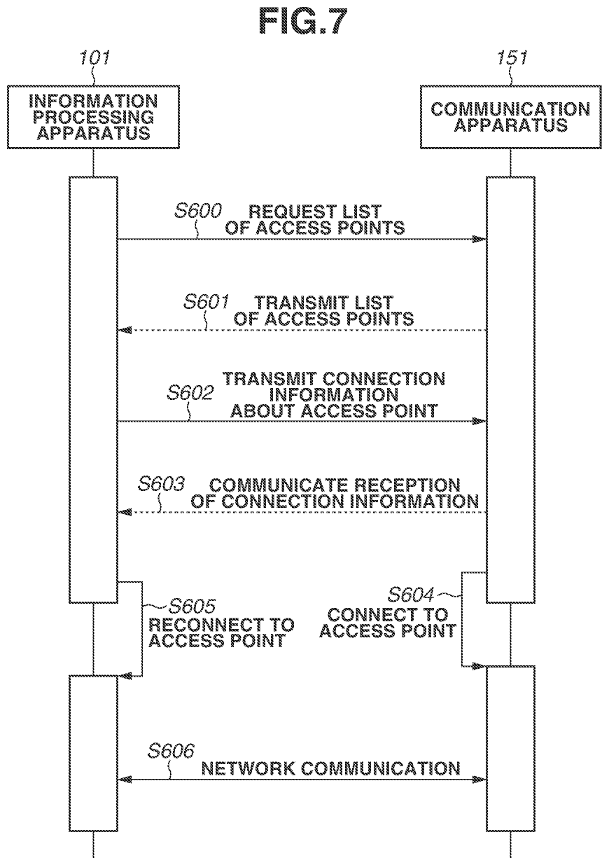

Next, processing which is performed by the information processing apparatus 101 and the communication apparatus 151 in step S223 is described with reference to FIG. 7. The sequence illustrated in FIG. 7 is implemented by, for example, a CPU of each apparatus reading out a program stored in, for example, a ROM of each apparatus or an external storage device onto a RAM of each apparatus and executing the program.

In step S600, the information processing apparatus 101 requests a list of access points from the communication apparatus 151 via a BLE connection between the communication apparatus 151 operating in the BLE setup mode and the information processing apparatus 101, by the setting application.

Next, in step S601, the communication apparatus 151 transmits a list of access points to the information processing apparatus 101 via a BLE connection between the communication apparatus 151 operating in the BLE setup mode and the information processing apparatus 101. Furthermore, the list to be transmitted here is a list showing one or a plurality of access points to which the communication apparatus 151 is able to connect, which has been discovered by the communication apparatus 151 performing access point (AP) search.

Next, in step S602, the information processing apparatus 101 transmits, to the communication apparatus 151, connection information about any one of access points included in the received list via a BLE connection between the communication apparatus 151 operating in the BLE setup mode and the information processing apparatus 101. Furthermore, the present processing is implemented by the setting application controlling the information processing apparatus 101 in such a way as to transmit connection information about any one of access points included in the received list. In the present processing, specifically, in a case where a connected AP is included in the received list, the information processing apparatus 101 transmits connection information about the connected AP. In the present example embodiment, since only access points to which the communication apparatus 151 is able to connect are included in the list, a case where a connected AP is included in the received list is thus a case where the communication apparatus 151 is able to connect to the connected AP. Moreover, in a case where the connected AP is not included in the received list, the information processing apparatus 101 displays the received list and receives, from the user, selection of any one of access points from the list. Then, the information processing apparatus 101 transmits connection information about the selected access point. In the present example embodiment, since only access points to which the communication apparatus 151 is able to connect are included in the list, a case where the connected AP is not included in the received list is thus a case where the communication apparatus 151 is not able to connect to the connected AP. Moreover, an access point which is connectable by an encryption method incompatible with the communication apparatus 151 is an access point to which the communication apparatus 151 is not able to connect and is, therefore, not included in the list. Moreover, an access point which is connectable by a frequency band incompatible with the communication apparatus 151 is an access point to which the communication apparatus 151 is not able to connect and is, therefore, not included in the list. Therefore, in step S223, which is performed in the case of NO in step S211 or in the case of NO in step S213, connection information about an access point different from the connected AP is transmitted as a result. Furthermore, in the case of NO in step S212, since the connected AP and the communication apparatus 151 may be able to connect to each other, connection information about the connected AP is likely to be transmitted or connection information about an access point different from the connected AP is likely to be transmitted. Furthermore, the present example embodiment is not limited to this configuration, and a configuration in which a list is always displayed and selection of an access point is received from the user each time can be employed. Furthermore, before connection information is transmitted, the information processing apparatus 101 receives, from the user, inputting of a password for connecting to an access point on a screen which the setting application displays. Then, the information processing apparatus 101 causes the received password to be included in connection information and then transmits the connection information.

In step S603, the communication apparatus 151 communicates reception of the connection information to the information processing apparatus 101 via a BLE connection between the communication apparatus 151 operating in the BLE setup mode and the information processing apparatus 101.

In step S604, the communication apparatus 151 ends the BLE setup mode and then transitions to the infrastructure mode. Furthermore, the BLE setup mode or the BLE connection can be configured not to be ended but to be maintained. Then, the communication apparatus 151 uses the connection information acquired in step S602 to try to connect to an access point corresponding to the connection information. In a case where the connection is successful, since then, the communication apparatus 151 becomes able to perform communication via a network which the connected access point forms.

In step S605, in a case where, when the setting operation has been performed, the information processing apparatus 101 has previously transmitted, to the communication apparatus 151, connection information about an access point different from the access point to which the information processing apparatus 101 has been connecting by Wi-Fi, the information processing apparatus 101 connects to such a different access point.

Furthermore, in a case where, when the setting operation has been performed, the information processing apparatus 101 has previously transmitted, to the communication apparatus 151, connection information about the access point to which the information processing apparatus 101 has been connecting by Wi-Fi, the present processing is omitted.

In step S606, the information processing apparatus 101 searches for the communication apparatus 151 on a network to which the information processing apparatus 101 itself belongs, by the setting application. Then, in a case where the communication apparatus 151 has been discovered, the information processing apparatus 101 requests capability information from the communication apparatus 151, and the communication apparatus 151 transmits capability information to the information processing apparatus 101. With this processing, the information processing apparatus 101 registers information about the communication apparatus 151 on the setting application, and, since then, becomes able to perform a communication with the communication apparatus 151 by the setting application. Specifically, for example, the information processing apparatus 101 becomes able to transmit a print job to the communication apparatus 151 by the setting application. Furthermore, at this time, in a case where the information processing apparatus 101 belongs to a network formed by an access point to which the communication apparatus 151 has connected by network setup, the information processing apparatus 101 becomes able to perform a communication with the communication apparatus 151 via the access point. Furthermore, in a case where a communication between the information processing apparatus 101 and the communication apparatus 151 is not able to be performed, such as a case where an access point to which the communication apparatus 151 has connected is not an access point to which the information processing apparatus 101 is connecting, a request or acquisition of capability information is omitted. Furthermore, a communication in step S606 is performed with use of, for example, a communication protocol different from the DPP (specifically, for example, CHMP). Then, the information processing apparatus 101 ends the processing in the present sequence.

Furthermore, the content of processing in the above-described sequence is not limited to the above-described content. For example, in a case where an access point to which the information processing apparatus 101 has been connecting by Wi-Fi when the setting operation has been performed is not included in the received list, the information processing apparatus 101 can be configured not to transmit connection information about the access point. Then, the information processing apparatus 101 can be configured not to try to establish a connection between the communication apparatus 151 and the access point. Then, the information processing apparatus 101 can be configured to receive, from the communication apparatus 151, connection information about an access point which is enabled within the communication apparatus 151 during the AP mode and then try to establish a connection between the communication apparatus 151 operating in the AP mode and the information processing apparatus 101. In the case of such a configuration, after transmitting connection information about an access point which is enabled within the communication apparatus 151 during the AP mode, the communication apparatus 151 transitions to the AP mode.

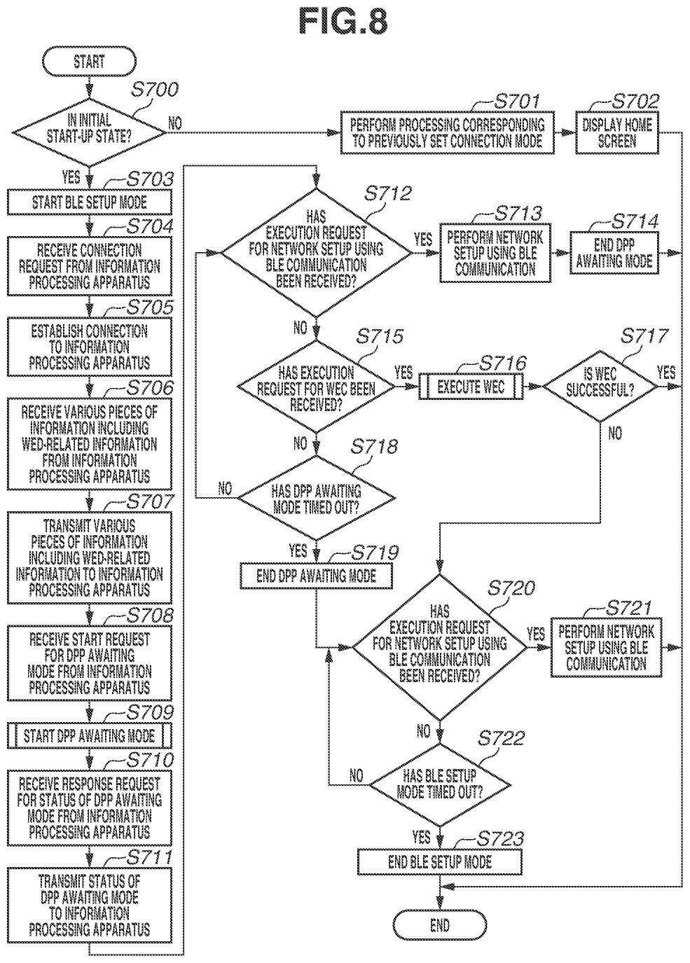

FIG. 8 and FIG. 9 are flowcharts illustrating the flow of processing which the communication apparatus 151 performs in the network setup processing in the present example embodiment. In the present example embodiment, the condition for the communication apparatus 151 starting an operation in the setup mode is assumed to include a first condition and a second condition. The first condition is “the communication apparatus 151 having being powered on by a power-on operation being performed on the communication apparatus 151 being in a state in which an initial setting thereof is not yet completed”. The second condition is “a predetermined operation for the network setup having been performed on the communication apparatus 151 being in a state of being powered on”. Processing in the setup mode which is started based on the first condition and processing in the setup mode which is started based on the second condition are described with reference to FIG. 8 and FIG. 9, respectively.

First, processing in the setup mode which is started based on the first condition is described.

The communication apparatus 151 performs an initial setting based on a power-on operation having been performed for the first time by the user in a factory shipment state (arrival state) (i.e., the first condition). Furthermore, the factory shipment state is equivalent to, for example, a state in which the communication apparatus 151 has not yet completed an initial setting thereof. For example, the communication apparatus 151 is shipped without, for example, an ink tank or a print head mounted thereon. Therefore, the communication apparatus 151 performs, as an initial setting, processing for making the communication apparatus 151 ready to be used, such as processing for prompting the user to mount, for example, an ink tank or print head, which is supplied with the communication apparatus 151, on the communication apparatus 151, registration adjustment processing, and cleaning processing for the print head. Whether the communication apparatus 151 is in the factory shipment state is controlled with use of a flag (initial start-up flag) stored in, for example, the ROM 152 or the memory. The communication apparatus 151 is configured to change the state of the initial start-up flag in response to the initial setting being completed and, after completion of the initial setting, prevent the initial setting from being started up even if the communication apparatus 151 is powered on. Since, to use the communication apparatus 151, it is favorable that network setup of the communication apparatus 151 is performed, in the present example embodiment, network setup processing is performed at the time of the initial setting.

FIG. 8 is a flowchart illustrating processing which the communication apparatus 151 performs in a case where a power-on operation has been performed on the communication apparatus 151. The flowchart illustrated in FIG. 8 is implemented, for example, by the CPU 154 reading out a setting application stored in, for example, the ROM 152 or the memory onto the RAM 153 and executing the setting application. Moreover, the flowchart illustrated in FIG. 8 is started based on the above-mentioned power-on operation having been performed.

In step S700, the CPU 154 refers to an initial start-up flag stored in, for example, the ROM 152 or the memory and determines whether the communication apparatus 151 is in the initial start-up state. For example, the initial start-up flag is previously set to a specific value indicating that the communication apparatus 151 is in the initial start-up state at the time of factory shipment. If the result of determination in step S700 is no (NO in step S700), the CPU 154 advances the processing to step S701, and, if the result of determination in step S700 is yes (YES in step S700), the CPU 154 advances the processing to step S703. Furthermore, the case where the result of determination in step S700 is no is a case where, in a state in which the initial setting of the communication apparatus 151 is already completed, the communication apparatus 151 has been powered on.

In step S701, the CPU 154 performs processing corresponding to a previously set connection mode stored in, for example, the ROM 152 or the memory. For example, in a case where, when the communication apparatus 151 has been powered off by the user, the communication apparatus 151 has been wirelessly connecting to an access point by Wi-Fi and the infrastructure mode is previously set, the communication apparatus 151 connects to the access point.

In step S702, the CPU 154 displays a standby screen (home screen), and then ends the processing in the present flowchart.

In step S703, the CPU 154 causes the communication apparatus 151 to start an operation in the BLE setup mode. Specifically, the CPU 154 transmits the above-mentioned advertising information for BLE. Additionally, the CPU 154 starts up a time-out timer for a mode capable of performing BLE communication, which is used to end the BLE setup mode if a predetermined time has elapsed, and thus counts a time elapsing after the operation in the BLE setup mode is started.

In step S704, the CPU 154 receives a request for connection to the communication apparatus 151 from the information processing apparatus 101.

In step S705, the CPU 154 establishes a BLE connection between the communication apparatus 151 and the information processing apparatus 101.

In step S706, the CPU 154 receives a request for various pieces of information related to WEC from the information processing apparatus 101 via the BLE connection established in step S705.

In step S707, the CPU 154 transmits various pieces of information related to WEC about the communication apparatus 151 to the information processing apparatus 101. Specifically, the STA state 1502 in the GATT database 1500 is read out by the information processing apparatus 101. For example, various pieces of information related to WEC about the communication apparatus 151 include the above-mentioned WEC-related information and information indicating whether the communication apparatus 151 is compatible with WEC. Furthermore, the information indicating whether the communication apparatus 151 is compatible with WEC is information indicating whether the communication apparatus 151 is compatible with the DPP. Furthermore, in a case where the communication apparatus 151 is not compatible with WEC, information indicating that the communication apparatus 151 is not compatible with WEC is transmitted and the WEC-related information is not transmitted. Moreover, in a case where the communication apparatus 151 is not compatible with WEC, neither the WEC-related information nor the information indicating whether the communication apparatus 151 is compatible with WEC needs to be transmitted.

In step S708, the CPU 154 receives a start request for the DPP awaiting mode. Specifically, the CPU 154 receives a start request for the DPP awaiting mode in response to a specific value being written in the Start Listen Mode 1503 in the GATT database 1500.

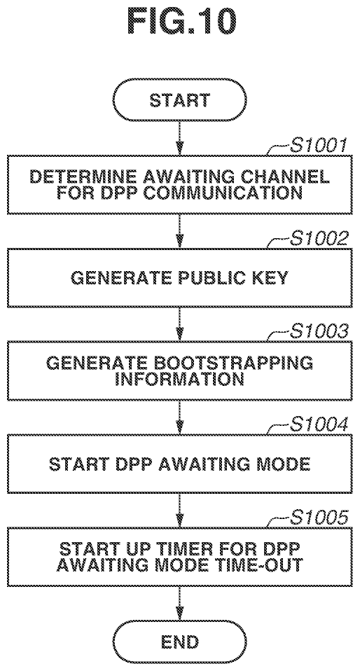

In step S709, the CPU 154 causes the communication apparatus 151 to start an operation in the DPP awaiting mode. Specifically, the CPU 154 changes the value of the STA state 1502 in the GATT database 1500 to a value indicating the DPP awaiting mode. Furthermore, the DPP awaiting mode is described below with reference to FIG. 10. Moreover, the CPU 154 starts up a time-out timer for the DPP awaiting mode and thus counts a time elapsing after the operation in the DPP awaiting mode is started.

In step S710, the CPU 154 receives a response information request for information concerning whether the communication apparatus 151 has started the DPP awaiting mode.

In step S711, the CPU 154 transmits information concerning whether the communication apparatus 151 has started the DPP awaiting mode to the information processing apparatus 101. Specifically, the STA state 1502, which has been changed to a value indicating the DPP awaiting mode, of the GATT database 1500 is read out by the information processing apparatus 101.

In step S712, the CPU 154 determines whether an execution request for network setup using the BLE communication has been received. Specifically, the CPU 154 determines whether the communication apparatus 151 has received a request for a list of access points from the information processing apparatus 101. If the result of determination in step S712 is yes (YES in step S712), the CPU 154 advances the processing to step S713, and, if the result of determination in step S712 is no (NO in step S712), the CPU 154 advances the processing to step S715.

In step S713, the CPU 154 performs network setup using the BLE communication. Specifically, the CPU 154 performs processing operations described as processing operations which the communication apparatus 151 performs out of the processing operations described above with reference to FIG. 7.

In step S714, the CPU 154 ends the DPP awaiting mode, and then ends the processing in the present flowchart. Furthermore, whichever of ending of the operation in the BLE setup mode and ending of the DPP awaiting mode can be performed first as long as both are after execution of the network setup using the BLE communication. Thus, the CPU 154 can end the operation in the BLE setup mode after ending the DPP awaiting mode. Moreover, ending of the operation in the BLE setup mode and ending of the DPP awaiting mode can be performed concurrently.

In step S715, which is performed in the case of NO in step S712, the CPU 154 determines whether an execution request for the network setup using the DPP (an execution request for WEC) has been received. Specifically, the CPU 154 determines whether the communication apparatus 151 has received, from the information processing apparatus 101, a network setup request using the DPP in the above-mentioned DPP authentication. If the result of determination in step S715 is yes (YES in step S715), the CPU 154 advances the processing to step S716, and, if the result of determination in step S715 is no (NO in step S715), the CPU 154 advances the processing to step S718. Furthermore, the CPU 154 can start up a timer for awaiting time-out of the network setup request using the DPP. In this case, the CPU 154 can change a channel which is used in the DPP communication when the count value of a time for awaiting time-out of the WEC execution request has exceeded a threshold value. Additionally, in a case where the communication apparatus 151 has not been able to receive the network setup request using the DPP even if the CPU 154 changes the channel which is used in the DPP communication more than a predetermined number of times, the CPU 154 can advance the processing to step S719. Then, the CPU 154 can end the DPP awaiting mode and await an execution request for network setup using the BLE communication.

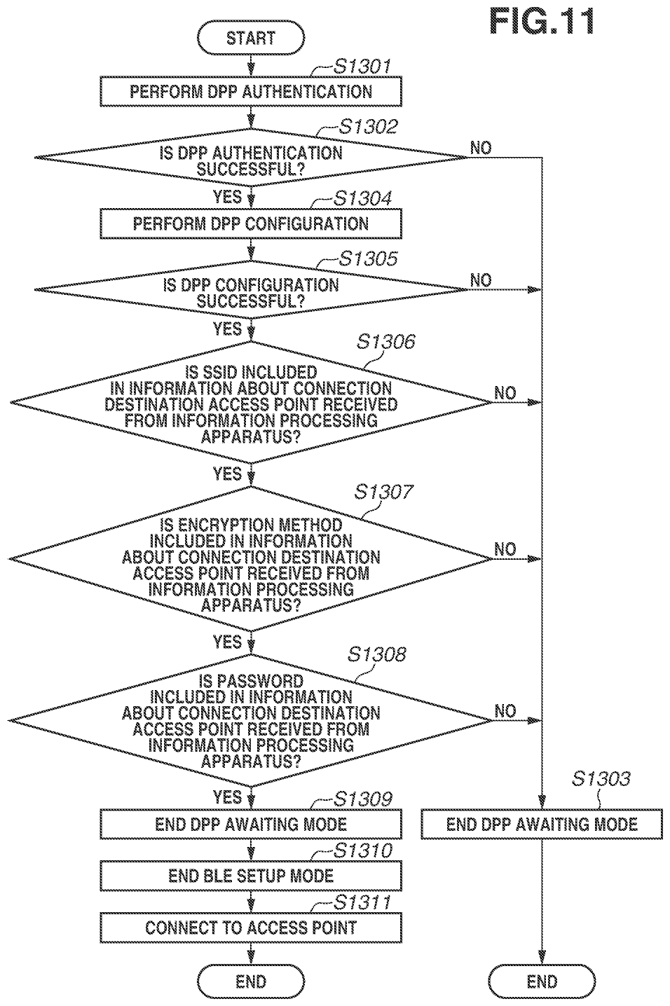

In step S716, the CPU 154 performs network setup using the DPP. Specifically, the CPU 154 performs processing operations described as processing operations which the communication apparatus 151 performs out of the processing operations described above with reference to FIG. 5, and then ends the processing in the present flowchart. The network setup using the DPP (WEC) is described below with reference to FIG. 11. Furthermore, the CPU 154 changes the Connect state 1504 to information indicating an infrastructure connection-in-progress state.

In step S717, the CPU 154 determines whether the establishment of a connection between an access point to which the information processing apparatus 101 is connecting and the communication apparatus 151 is successful by the executed WEC. The result of the present determination is yes (successful) in a case where the connection between the communication apparatus 151 and the information processing apparatus 101 is successful, i.e., in a case where the communication apparatus 151 has connected to an access point which the communication apparatus 151 has received in the DPP configuration. Then, the CPU 154 changes the Connect state 1504 to a state indicating that the infrastructure connection is successful. Moreover, the result of the present determination is no (failed) in a case where the result of each determination illustrated in FIG. 11 in step S716 is no and processing for ending the DPP awaiting mode without performing connection to an access point has been performed. Additionally, the result of the present determination is also no (failed) in a case where, even when the communication apparatus 151 has connected to an access point in step S1311 illustrated in FIG. 11, the connected access point is an access point other than the access point which the communication apparatus 151 has received in the DPP configuration. Furthermore, while, in the present example embodiment, the access point which the communication apparatus 151 has received in the DPP configuration is an access point to which the information processing apparatus 101 is connecting, as long as the communication apparatus 151 is connecting to an access point, even if the connected access point is not an access point to which the information processing apparatus 101 is connecting, the result of the present determination can be yes (successful). If the result of determination in step S717 is yes (YES in step S717), the CPU 154 ends the processing in the present flowchart, and, if the result of determination in step S717 is no (NO in step S717), the CPU 154 advances the processing to step S720. Furthermore, in a case where the result of each determination illustrated in FIG. 11 in step S716 is yes, the CPU 154 can determine that WEC is successful and then perform connection to an access point and end the DPP awaiting mode, and the sequence of processing operations is not considered. Then, if, in step S720, it is determined that the communication apparatus 151 has received an execution request for network setup using the BLE communication (YES in step S720), then in step S721, the CPU 154 executes the network setup using the BLE communication. Thus, in a case where the establishment of a connection between an access point and the communication apparatus 151 is failed by the executed WEC, the network setup using the BLE communication is performed. With this processing, it is possible to more surely perform the establishment of a connection between an access point and the communication apparatus 151.

In step S718, the CPU 154 determines whether the DPP awaiting mode has timed out with the value counted by the timer for time-out of the DPP awaiting mode exceeding a threshold value. If the result of determination in step S718 is yes (YES in step S718), the CPU 154 advances the processing to step S719, and, if the result of determination in step S718 is no (NO in step S718), the CPU 154 returns the processing to step S712.

In step S719, the CPU 154 ends the DPP awaiting mode, and then advances the processing to step S720.

Processing operations in steps S720 and S721 are similar to those in steps S712 and 5713, respectively, and are, therefore, omitted from the description. Furthermore, if the result of determination in step S720 is yes (YES in step S720), the CPU 154 advances the processing to step S721, and, if the result of determination in step S720 is no (NO in step S720), the CPU 154 advances the processing to step S722.

In step S722, the CPU 154 determines whether the mode capable of performing the BLE communication has timed out with the value counted by the timer for time-out of the BLE setup mode exceeding a threshold value. If the result of determination in step S722 is yes (YES in step S722), the CPU 154 advances the processing to step S723, and, if the result of determination in step S722 is no (NO in step S722), the CPU 154 returns the processing to step S720.

In step S723, the CPU 154 ends an operation in the BLE setup mode and thus ends transmission of advertising information for BLE. This enables reducing a setup which is not intended by the user. Then, the CPU 154 ends the processing in the present flowchart.

Furthermore, after completion of the initial setting, the CPU 154 changes the value of the initial start-up flag stored in, for example, the ROM 152 or the memory from a value indicating the initial start-up state to a value indicating a non-initial start-up state. Furthermore, the non-initial start-up state is equivalent to a state in which the initial setting has been completed. With this processing, the initial setting is completed, so that, in a case where the communication apparatus 151 is powered on by the user the next and subsequent times, the processing in the flowchart of FIG. 8 is not performed.

Next, setup processing in the setup mode which is started based on the second condition is described.

FIG. 9 is a flowchart illustrating setup processing which the communication apparatus 151 performs. The flowchart illustrated in FIG. 9 is implemented, for example, by the CPU 154 reading out a setting application stored in, for example, the ROM 152 or the memory onto the RAM 153 and executing the setting application. The flowchart of FIG. 9 is performed based on the above-mentioned second condition being satisfied.

In step S800, the communication apparatus 151 determines whether the connection mode is currently set to the communication apparatus 151 when the setting operation has been performed. If the result of determination in step S800 is yes (YES in step S800), the communication apparatus 151 advances the processing to step S801, and, if the result of determination in step S800 is no (NO in step S800), the communication apparatus 151 advances the processing to step S802.

In step S801, the communication apparatus 151 disables the connection mode, which is currently set to the communication apparatus 151 at least when the setting operation has been performed. For example, in a case where the infrastructure mode is currently set to the communication apparatus 151 at least when the setting operation has been performed and the communication apparatus 151 is wirelessly connecting to an access point by Wi-Fi, the communication apparatus 151 disables the infrastructure mode, thus severing a connection with the access point. Moreover, the communication apparatus 151 acquires information concerning a connection mode to which the communication apparatus 151 is currently set at least when the setting operation has been performed, and then stores the acquired information in, for example, the ROM 152 or the memory. This is because such information is information needed to perform reconnection in a connection mode to which the communication apparatus 151 is previously set at least when the setting operation has been performed in step S822 described below. For example, the communication apparatus 151 acquires information concerning an access point to which the communication apparatus 151 has been wirelessly connecting by Wi-Fi at least when the setting operation has been performed, and then stores the acquired information in, for example, the ROM 152 or the memory. Such information includes information required for connecting to an access point to which the communication apparatus 151 is wirelessly connecting by Wi-Fi (e.g., an SSID or information indicating an encryption method). Furthermore, in a case where no connection mode is currently set at least when the setting operation has been performed, acquisition of information about a connection mode is omitted.

Processing operations in steps S802 to S822 are similar to those in steps S703 to S723, and are, therefore, omitted from description.

In step S823, the communication apparatus 151 performs reconnection in a connection mode which has been set at least when the setting operation has been performed with use of the information concerning a connection mode to which the communication apparatus 151 is currently set at least when the setting operation has been performed, acquired in step S801. For example, the communication apparatus 151 reconnects to an access point to which the communication apparatus 151 has been wirelessly connecting by Wi-Fi at least when the setting operation has been performed.

Here, processing in each of step S709 illustrated in FIG. 8 and step S808 illustrated in FIG. 9 is described with reference to FIG. 10.

FIG. 10 is a flowchart illustrating the content of DPP awaiting mode start processing. The flowchart illustrated in FIG. 10 is implemented, for example, by the CPU 154 reading out a setting application stored in, for example, the ROM 152 or the memory onto the RAM 153 and executing the setting application. Moreover, the flowchart illustrated in FIG. 10 is started based on the communication apparatus 151 receiving a start request for the DPP awaiting mode from the information processing apparatus 101.

In step S1001, the CPU 154 determines an awaiting channel for the DPP communication. The awaiting channel for the DPP communication means a channel for receiving a network setup request using the DPP transmitted from the information processing apparatus 101. Moreover, the same channel is also used for the DPP authentication and DPP configuration processing. Furthermore, which channel to use as the channel for the DPP communication can be set, for example, by the user via an operation screen of the communication apparatus 151.

In step S1002, the CPU 154 generates the above-mentioned public key information for use in performing secure communication with the information processing apparatus 101.

In step S1003, the CPU 154 generates the above-mentioned bootstrapping information. The bootstrapping information includes, for example, identification information (e.g., MAC address) about the communication apparatus 151, information concerning an awaiting channel for the DPP communication, and public key information generated in step S1002.

In step S1004, the CPU 154 starts the DPP awaiting mode. When the DPP awaiting mode is started, a DPP connection between the communication apparatus 151 and the information processing apparatus 101 is established, so that a communication in the DPP authentication is enabled.

In step S1005, the CPU 154 starts up a timer for DPP awaiting mode time-out. Furthermore, after starting an operation in the DPP awaiting mode, the CPU 154 ends the operation in the DPP awaiting mode when a predetermined time has elapsed. This is because, by ending the operation in the DPP awaiting mode, the CPU 154 transitions to network setup processing using the BLE communication. Specifically, when the value counted by the timer for DPP awaiting mode time-out exceeds a threshold value in step S717 or S816 and, thus, time-out of the network setup mode occurs, the CPU 154 ends the DPP awaiting mode.

Then, the CPU 154 advances the processing to step S710 illustrated in FIG. 8 or step S809 illustrated in FIG. 9.

Here, processing in each of step S716 illustrated in FIG. 8 and step S815 illustrated in FIG. 9 is described with reference to FIG. 11.

FIG. 11 is a flowchart illustrating execution processing of the network setup using the DPP (WEC), which is equivalent to an operation of the communication apparatus 151 in the sequence illustrated in FIG. 5. The flowchart illustrated in FIG. 11 is implemented, for example, by the CPU 154 reading out a setting application stored in, for example, the ROM 152 or the memory onto the RAM 153 and executing the setting application. Moreover, the flowchart illustrated in FIG. 11 is started based on the communication apparatus 151 receiving an execution request for WEC in the DPP authentication processing from the information processing apparatus 101.

In step S1301, the CPU 154 performs DPP authentication processing. As mentioned above, in the DPP authentication processing, for example, authentication information and information used for encrypting information are communicated between the information processing apparatus 101 and the communication apparatus 151, so that authentication in communication between apparatuses is performed. Furthermore, in the DPP authentication, a communication is performed with use of the DPP.

In step S1302, the CPU 154 determines whether the DPP authentication processing with the information processing apparatus 101 is successful. As mentioned above, various pieces of information which are transmitted from the information processing apparatus 101 in communications in the DPP authentication are encrypted based on WEC-related information acquired by the information processing apparatus 101 in the processing illustrated in FIGS. 3A and 3B. When succeeding in decrypting the information received from the information processing apparatus 101 with a decryption key stored in advance, the CPU 154 authenticates a communication with the information processing apparatus 101. Furthermore, in a case where the information processing apparatus 101 has not been able to acquire accurate WEC-related information and, thus, has not been able to accurately encrypt the information, since decryption by the communication apparatus 151 is failed, authentication is failed. Therefore, in a case where the authentication in communication with the information processing apparatus 101 is successful, the CPU 154 determines that DPP authentication processing is successful, and, in a case where the authentication in communication with the information processing apparatus 101 is failed, the CPU 154 determines that DPP authentication processing is failed. If the result of determination in step S1302 is no (NO in step S1302), then in step S1303, the CPU 154 ends the DPP awaiting mode and then ends the processing in the present flowchart. On the other hand, if the result of determination in step S1302 is yes (YES in step S1302), the CPU 154 advances the processing to step S1304.

In step S1304, the CPU 154 performs DPP configuration processing. In the DPP configuration processing, the CPU 154 receives, from the information processing apparatus 101 by WEC, connection information for connecting to an access point set as a setting target by WEC. Furthermore, the connection information includes, for example, the SSID of an access point set as a setting target by WEC and information indicating a password and an encryption method thereof.

In step S1305, the CPU 154 determines whether the DPP configuration processing with the information processing apparatus 101 is successful. Specifically, in a case where the CPU 154 has received connection information for connecting to an access point set as a setting target by WEC from the information processing apparatus 101 by WEC, the CPU 154 determines that the DPP configuration processing is successful, and, in a case where the CPU 154 has not been able to receive the connection information by WEC, the CPU 154 determines that the DPP configuration processing is failed. If the result of determination in step S1305 is no (NO in step S1305), then in step S1303, the CPU 154 ends the DPP awaiting mode and then ends the processing in the present flowchart. On the other hand, if the result of determination in step S1305 is yes (YES in step S1305), the CPU 154 advances the processing to step S1306. Furthermore, if the DPP configuration processing is successful, the communication apparatus 151 acquires the SSID, an encryption method, and a password of the access point.

In step S1306, the CPU 154 determines whether an SSID is included in information about the access point set as a setting target by WEC received from the information processing apparatus 101. If the result of determination in step S1306 is no (NO in step S1306), then in step S1303, the CPU 154 ends the DPP awaiting mode and then ends the processing in the present flowchart. On the other hand, if the result of determination in step S1306 is yes (YES in step S1306), the CPU 154 advances the processing to step S1307.

In step S1307, the CPU 154 determines whether an encryption method is included in information about the access point set as a setting target by WEC received from the information processing apparatus 101. If the result of determination in step S1307 is no (NO in step S1307), then in step S1303, the CPU 154 ends the DPP awaiting mode and then ends the processing in the present flowchart. On the other hand, if the result of determination in step S1307 is yes (YES in step S1307), the CPU 154 advances the processing to step S1308.

In step S1308, the CPU 154 determines whether a password is included in information about the access point set as a setting target by WEC received from the information processing apparatus 101. Furthermore, in a case where the communication apparatus 151 connects to the access point via the DPP communication, the CPU 154 can determine whether not a password but public key information is included in the information. Moreover, in a case where the security setting of an access point set as a setting target is set disabled, a password does not need to be included in the information. If the result of determination in step S1308 is no (NO in step S1308), then in step S1303, the CPU 154 ends the DPP awaiting mode and then ends the processing in the present flowchart. On the other hand, if the result of determination in step S1308 is yes (YES in step S1308), then in step S1309, the CPU 154 ends the DPP awaiting mode. If the CPU 154 ends the DPP awaiting mode, the CPU 154 is not able to respond to a request for DPP authentication processing transmitted from the information processing apparatus 101.

In step S1310, the CPU 154 ends an operation in the BLE setup mode. Furthermore, the CPU 154 can continue an operation in a mode capable of executing BLE, or can end an operation in a mode capable of executing BLE and end transmission of advertising information for BLE. Furthermore, whichever of ending of the operation in the BLE setup mode in step S1310 and ending of the operation in the DPP awaiting mode in step S1309 can be performed first. Thus, the CPU 154 can end the operation in the BLE setup mode after ending the operation in the DPP awaiting mode. Moreover, ending of the operation in the BLE setup mode and ending of the operation in the DPP awaiting mode can be performed concurrently. Additionally, the sequence of processing for ending an operation in the BLE setup mode or processing for ending an operation in the DPP awaiting mode and processing for connecting to an access point is not considered.

In step S1311, the CPU 154 connects to an access point set as a setting target by WEC with use of various pieces of information about the access point set as a setting target by WEC received from the information processing apparatus 101. Furthermore, the various pieces of information include an SSID, a password, and an encryption method. Then, the communication apparatus 151 ends the processing in the present flowchart.

As described above, in the present example embodiment, the information processing apparatus 101 makes a start request for the DPP awaiting mode to the communication apparatus 151 via a BLE connection with the communication apparatus 151. Then, the communication apparatus 151 starts the DPP awaiting mode. With this processing, the information processing apparatus 101 becomes able to execute WEC at timing when the information processing apparatus 101 intends to execute WEC. Additionally, causing the DPP awaiting mode to be started only at timing when the information processing apparatus 101 intends to execute WEC enables reducing execution of a network setup which the user does not intend to perform.

This enables increasing the convenience of a network setup function.

Furthermore, while, in the present example embodiment, a configuration in which the network setup is performed via the BLE communication has been described, the network setup can be performed via a communication method other than the BLE communication. For example, the network setup can be performed via a Wi-Fi communication as a communication method other than the BLE communication. The communication apparatus 151 enables an access point for setup in a case where the first condition or the second condition is satisfied. Therefore, the information processing apparatus 101 is able to sever a Wi-Fi connection with the connected AP and establish a Wi-Fi connection with the access point enabled by the communication apparatus 151 operating in the network setup mode. Furthermore, whichever of the BLE setup mode and enabling of the access point for setup can be performed first, both can be performed concurrently, or any one can be started based on the other being performed. With this processing, the information processing apparatus 101 can transmit information indicating a DPP awaiting mode start request or acquire various pieces of information about the communication apparatus 151 via a connection between the information processing apparatus 101 and the communication apparatus 151 using the Wi-Fi communication. After that, the information processing apparatus 101 can establish a Wi-Fi connection with the connected AP again and transmit connection information about the connected AP to the communication apparatus 151 via the DPP. Moreover, in a case where the DPP connection is failed, the information processing apparatus 101 can sever a Wi-Fi connection with the connected AP and re-establish a Wi-Fi connection with an access point enabled by the communication apparatus 151 operating in the network setup mode. Then, the information processing apparatus 101 can transmit the connection information via a connection between the information processing apparatus 101 and the communication apparatus 151 using the Wi-Fi communication. Furthermore, even in this configuration, a communication protocol different from the DPP is assumed to be used. Moreover, which of the BLE communication and the Wi-Fi communication is used in the network setup is determined by a user operation performed on the setting application. Thus, the network setup is performed by a communication method selected by the user on a screen of the setting application.

Moreover, while, in the present example embodiment, the communication apparatus 151 ends the DPP awaiting mode in a case where execution of WEC is failed, a configuration in which the communication apparatus 151 does not end the DPP awaiting mode even in such a case can be employed. This enables performing the network setup again in response to an execution request for the network setup or an execution request for WEC transmitted from the information processing apparatus 101.

Additionally, in the present example embodiment, in a case where the communication apparatus 151 has received any one of an execution request for the network setup using the BLE communication and an execution request for WEC, the communication apparatus 151 also enables a mode concerning the other execution request. Thus, even in a case where the communication apparatus 151 has received an execution request for the network setup using the BLE communication, the communication apparatus 151 enables the DPP awaiting mode. However, in a case where the communication apparatus 151 has received any one of an execution request for the network setup using the BLE communication and an execution request for WEC, the communication apparatus 151 can disable a mode concerning the other execution request. For example, in a case where the communication apparatus 151 has received an execution request for WEC, the communication apparatus 151 can end an operation in the network setup mode using the BLE communication. However, in a case where execution of WEC is failed, the communication apparatus 151 re-starts the network setup mode using the BLE communication based on execution of WEC being failed. This enables performing the network setup using the BLE communication again in response to an execution request for the network setup transmitted from the information processing apparatus 101. Additionally, in a case where the communication apparatus 151 has received any one of an execution request for the network setup using the BLE communication and an execution request for WEC, disabling a mode concerning the other execution request enables reducing a network setup which is not intended by the user from being performed.

In addition, in the present example embodiment, in a case where the communication apparatus 151 is able to connect to a predetermined access point set as a setting target, the information processing apparatus 101 is controlled to transmit connection information about the predetermined access point to the communication apparatus 151 by WEC. Moreover, in a case where the communication apparatus 151 is not able to connect to a predetermined access point set as a setting target, the information processing apparatus 101 is controlled to transmit connection information about an access point different from the predetermined access point to the communication apparatus 151 by the network setup. Furthermore, the case where the communication apparatus 151 is able to connect to the predetermined access point is, for example, a case where the communication apparatus 151 is compatible with an encryption method used for connection to the predetermined access point or a case where the communication apparatus 151 is compatible with a frequency band used for connection to the predetermined access point. Then, the case where the communication apparatus 151 is not able to connect to the predetermined access point is, for example, a case where the communication apparatus 151 is not compatible with an encryption method used for connection to the predetermined access point or a case where the communication apparatus 151 is not compatible with a frequency band used for connection to the predetermined access point. Furthermore, in the present example embodiment, even in a case where the communication apparatus 151 is able to connect to the predetermined access point, if WEC is not compatible with an encryption method used for connection to the predetermined access point, the information processing apparatus 101 is controlled to transmit connection information about an access point different from the predetermined access point to the communication apparatus 151 by the network setup.

With such a configuration employed, in a case where the connection between the predetermined access point and the communication apparatus 151 is able to be established by WEC, performing setup by WEC enables implementing a simple setup with, for example, inputting of a password by the user omitted. Moreover, in a case where the connection between the predetermined access point and the communication apparatus 151 is not able to be established by WEC, performing setup by a function different from WEC enables surely performing the establishment of a connection between the access point and the communication apparatus 151.

While, in the above-described example embodiment, connection information about the connected AP is assumed to be transmitted by WEC and, in various determinations such as those in steps S211 to S213, the determination is performed with regard to the connected AP, the present example embodiment is not limited to this configuration. Connection information about an AP different from the connected AP can be transmitted or the determination can be performed with regard to an AP different from the connected AP. Specifically, the AP different from the connected AP can be, for example, an access point to which the information processing apparatus 101 has not been connecting when the setting operation has been performed but to which the information processing apparatus 101 has been connected at some point before the setting operation is performed. Moreover, the AP different from the connected AP can be an access point selected by the user from a list of access points to which the information processing apparatus 101 has been connected at some point. This is because connection information about an access point to which the information processing apparatus 101 has been connected at some point is able to be transmitted by WEC if the connection information is stored in the OS.

Furthermore, in the above-described example embodiment, performing setup by WEC enables implementing a simple setup with, for example, inputting of a password by the user omitted. However, the setup can be performed by another function different from WEC. For example, the setup can be performed by a function using the Hyper Text Transfer Protocol.

In this case, as with WEC, a simple setup with, for example, inputting of a password by the user omitted can be implemented. Additionally, in the above-described example embodiment, a setup using a communication protocol for setup (for example, the Simple Network Management Protocol (SNMP)) is performed. However, the setup can be performed by another function different from the setup using a communication protocol for setup. For example, the setup can be performed by a function using the Hyper Text Transfer Protocol.

Additionally, in the above-described example embodiment, a configuration in which, in step S207, various pieces of information are acquired via a BLE connection between the communication apparatus 151 operating in the BLE setup mode and the information processing apparatus 101 has been described. However, the present example embodiment is not limited to this configuration. Various pieces of information can be acquired by reading of a QR code such as that in step S221, or can be acquired via a communication of another communication method, such as NFC or Wi-Fi.

### Other Embodiments

Various embodiments of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random access memory (RAM), a read-only memory (ROM), a storage of distributed computing systems, an optical disk (such as a compact disc (CD), digital versatile disc (DVD), or Blu-ray Disc (BD)™), a flash memory device, a memory card, and the like.

While example embodiments are described, it is to be understood that the disclosure is not limited to the disclosed example embodiments. The scope of the following claims is to be accorded the broadest interpretation so as to encompass all such modifications and equivalent structures and functions.

This application claims the benefit of Japanese Patent Application No. 2021-152129 filed Sep. 17, 2021, which is hereby incorporated by reference herein in its entirety.

What is claimed is:

1. A communication apparatus configured to communicate with an information processing apparatus, the communication apparatus comprising:
a first control unit configured to, based on a start request being received from the information processing apparatus via first communication with the information processing apparatus using a first protocol, perform first control to start a first state capable of performing second communication with the information processing apparatus using a second protocol different from the first protocol;
a transmission unit configured to transmit second protocol related information to be used for the second communication with the information processing apparatus using the second protocol, the second protocol related information being transmitted via the first communication with the information processing apparatus using the first protocol;
a communication unit configured to perform the second communication with the information processing apparatus using the second protocol, the second communication being based on the second protocol related information transmitted using the first protocol; and
a second control unit configured to, in a case where connection information to be used for the communication apparatus to connect to an access point has been acquired from the information processing apparatus via the second communication, perform second control to establish a connection between the communication apparatus and the access point using the connection information.

2. The communication apparatus according to claim 1, further comprising a first transmission unit configured to, in a case where the communication apparatus has acquired a request for response information indicating whether the communication apparatus has started the first state, transmit the response information indicating whether the communication apparatus has started the first state to the information processing apparatus.

3. The communication apparatus according to claim 1, further comprising a second transmission unit configured to transmit information indicating whether the communication apparatus has succeeded in establishing a connection with the access point to the information processing apparatus via the first communication using the first protocol.

4. The communication apparatus according to claim 1, wherein the connection information is information including at least one of a service set identifier (SSID), an encryption method, and a password or public key information of the access point.

5. The communication apparatus according to claim 1, further comprising a generation unit configured to generate information to be used for the second communication with the information processing apparatus using the second protocol.

6. The communication apparatus according to claim 5, wherein the information to be used for the second communication with the information processing apparatus using the second protocol includes at least one of identification information about the communication apparatus, public key information, and information indicating a channel which is used in the second communication with the information processing apparatus using the second protocol.

7. The communication apparatus according to claim 1, further comprising a third transmission unit configured to transmit information to be used for the second communication with the information processing apparatus using the second protocol to the information processing apparatus.

8. The communication apparatus according to claim 1, further comprising a printing unit configured to cause the communication apparatus to perform printing via the access point to which the communication apparatus has connected.

9. The communication apparatus according to claim 1, wherein the second protocol is Device Provisioning Protocol.

10. The communication apparatus according to claim 1, wherein the second protocol is Hypertext Transfer Protocol.

11. The communication apparatus according to claim 1, wherein the first protocol is Simple Network Management Protocol.

12. The communication apparatus according to claim 1, wherein each of the first communication with the information processing apparatus using the first protocol and the second communication with the information processing apparatus using the second protocol is a communication that is based on IEEE 802.11.

13. The communication apparatus according to claim 1, wherein the first protocol is Generic Attribute Profile.

14. The communication apparatus according to claim 1, wherein the first communication with the information processing apparatus using the first protocol is a communication that is based on Bluetooth®.

15. The communication apparatus according to claim 1, wherein the first communication with the information processing apparatus using the first protocol is a communication that is based on Bluetooth® Low Energy.

16. The communication apparatus according to claim 1, wherein the communication apparatus ends the first state based on a predetermined time to end the first state having elapsed.

17. A control method for a communication apparatus configured to communicate with an information processing apparatus, the control method comprising:
based on a start request being received from the information processing apparatus via first communication with the information processing apparatus using a first protocol, performing first control to start a first state capable of performing second communication with the information processing apparatus using a second protocol different from the first protocol;
transmitting second protocol related information to be used for the second communication with the information processing apparatus using the second protocol, the second protocol related information being transmitted via the first communication with the information processing apparatus using the first protocol;
performing the second communication with the information processing apparatus using the second protocol, the second communication being based on the second protocol related information transmitted using the first protocol; and
in a case where connection information to be used for the communication apparatus to connect to an access point has been acquired from the information processing apparatus via the second communication, performing second control to establish a connection between the communication apparatus and the access point using the connection information.

18. A non-transitory computer-readable storage medium storing computer-executable instructions that, when executed by a computer of a communication apparatus configured to communicate with an information processing apparatus, cause the computer to perform a method comprising:
based on a start request being received from the information processing apparatus via first communication with the information processing apparatus using a first protocol, performing first control to start a first state capable of performing second communication with the information processing apparatus using a second protocol different from the first protocol;
transmitting second protocol related information to be used for the second communication with the information processing apparatus using the second protocol, the second protocol related information being transmitted via the first communication with the information processing apparatus using the first protocol;
performing the second communication with the information processing apparatus using the second protocol, the second communication being based on the second protocol related information transmitted using the first protocol; and
in a case where connection information to be used for the communication apparatus to connect to an access point has been acquired from the information processing apparatus via the second communication, performing second control to establish a connection between the communication apparatus and the access point using the connection information.
